(19) United States
(12) Patent Application Publication
(10) Pub. No.: US 2013/0169753 A1
(43) Pub. Date: Jul. 4, 2013

(54) BROADCAST RECEIVER AND METHOD FOR PROCESSING 3D VIDEO DATA

(71) Applicants: Joonhui Lee, Seoul (KR); Jeehyun Choe, Seoul (KR); Jongyeul Suh, Seoul (KR); Jeonghyu Yang, Seoul (KR)

(72) Inventors: Joonhui Lee, Seoul (KR); Jeehyun Choe, Seoul (KR); Jongyeul Suh, Seoul (KR); Jeonghyu Yang, Seoul (KR)

(21) Appl. No.: 13/822,668

(22) PCT Filed: Sep. 14, 2011
(86) PCT No.: PCT/KR11/06782

§ 371 Date: Mar. 13, 2013

Related U.S. Application Data
(60) Provisional application No. 61/384,304, filed on Sep. 19, 2010.

(51) Int. Cl. H04N 13/00

(52) U.S. Cl. CPC H04N 13/0048
USPC 348/43

(57) ABSTRACT

According to one embodiment of the present invention a method for processing 3D video data comprises the steps of: receiving a broadcast signal including 3D video data and service information; identifying whether or not a corresponding virtual channel provides 3D service from a first signaling table in the service information; extracting a service identifier and a stereo format descriptor including first component information on the 3D service from the first signaling table; reading second component information corresponding to the first component information from a second signaling table having a program number mapped in the service identifier for the virtual channel, and extracting basic PID information on the basis of the read second component information; extracting stereo format information on a stereo video element from the stereo format descriptor; and decoding the stereo video element on the basis of the extracted stereo format information and outputting the decoded stereo video element.

### TECHNICAL FIELD

The present invention relates to an apparatus and method for processing a broadcast signal, and more particularly, to a broadcast receiver that processes video data when a plurality of video streams is transmitted from a 3-dimensional (3D) broadcasting system and a method of processing 3D video data.

### BACKGROUND ART

Generally, a 3-dimensional (3D) image (or stereoscopic image) provides a stereoscopic effect using a stereo vision principle. Humans experience a perspective effect through binocular parallax, i.e. parallax based on the distance between the two eyes, which is about 65 mm. Consequently, the 3D image may provide a stereoscopic effect and a perspective effect based on a planar image related to the left eye and the right eye.

A 3D image display method may include a stereoscopic type display method, a volumetric type display method, and a holographic type display method. In the stereoscopic type display method, a left view image, which is viewed through the left eye, and a right view image, which is viewed through the right eye, are provided, and a user views the left view image and the right view image through the left eye and the right eye, respectively, using polarized glasses or a display device to perceive a 3D effect.

### DISCLOSURE

### Technical Problem

An object of the present invention is to transmit and receive information regarding 3D video data in a case in which a plurality of video streams is transmitted for stereoscopic display in a 3D broadcasting system and to process 3D video data using the information, thereby providing a user with a more convenient and efficient broadcast environment.

### Technical Solution

In order to accomplish the above object, an example of a 3D video data processing method according to an embodiment of the present invention includes receiving a broadcast signal including 3D video data and service information, identifying whether a 3D service is provided in a corresponding virtual channel from a first signaling table in the service information, extracting a stereo format descriptor including a service identifier and first component information regarding the 3D service from the first signaling table, reading second component information corresponding to the first component information from a second signaling table having a program number mapped with the service identifier for the virtual channel and extracting elementary PID information based on the read second component information, extracting stereo format information regarding a stereo video element from the stereo format descriptor, and decoding and outputting the stereo video element based on the extracted stereo format information.

Also, another example of a 3D broadcast receiver according to an embodiment of the present invention includes a receiving unit to receive a broadcast signal including 3D video data and service information, a system information processor to acquire a first signaling table and a second signaling table in the service information and to acquire stereo format information from the first signaling table and the second signaling table, a controller to identify whether a 3D service is provided in a corresponding virtual channel from the first signaling table, to control a service identifier to be read from the first signaling table, first component information regarding the 3D service and stereo format information regarding a stereo video element to be read from the stereo format information, and second component information corresponding to the first component information to be read from the second signaling table having a program number mapped with the service identifier for the virtual channel, and to control elementary PID information to be extracted based on the read second component information, a decoder to decode the stereo video element based on the extracted stereo format information, and a display unit to output the decoded 3D video data according to a display type.

### Advantageous Effects

The present invention has the following effects.

First, in a case in which a 3D broadcast service is provided, it is possible for a receiver to process received 3D video data such that a 3D effect designed when the 3D broadcast service is produced is reflected.

Second, it is possible to efficiently provide a 3D broadcast service while minimizing an influence on an existing 2D broadcast service.

### DESCRIPTION OF DRAWINGS

FIG. 1 is a view showing a stereoscopic image multiplexing format of a single video stream format;

FIG. 2 is a view illustrating a method of a multiplexing a stereoscopic image in a top-bottom mode according to an embodiment of the present invention to configure an image;

FIG. 3 is a view illustrating a method of a multiplexing a stereoscopic image in a side-by-side mode according to an embodiment of the present invention to configure an image;

FIG. 4 is a view showing a syntax structure of a TVCT including stereo format information according to an embodiment of the present invention;

FIG. 5 is a view illustrating a syntax structure of a stereo format descriptor included in TVCT table sections according to an embodiment of the present invention;

FIG. 6 is a view illustrating a syntax structure of a PMT including stereo format information according to an embodiment of the present invention;

FIG. 7 is a view illustrating a syntax structure of a stereo format descriptor included in a PMT according to an embodiment of the present invention;

FIG. 8 is a view illustrating a bitstream syntax structure of SDT table sections according to an embodiment of the present invention;

FIG. 9 is a view illustrating an example of configuration of a service_type field according to the present invention;

FIG. 10 is a view illustrating a syntax structure of a stereo format descriptor included in an SD according to an embodiment of the present invention;

FIG. 11 is a view illustrating a broadcast receiver according to an embodiment of the present invention;

FIG. 12 is a flowchart showing a 3D video data processing method of a broadcast receiver according to an embodiment of the present invention;

FIG. 13 is a view showing configuration of a broadcast receiver to output received 3D video data as a 2D image using 3D image format information according to an embodiment of the present invention;

FIG. 14 is a view showing a method of outputting received 3D video data as a 2D image using stereo format information according to an embodiment of the present invention;

FIG. 15 is a view showing a method of outputting received 3D video data as a 2D image using 3D image format information according to another embodiment of the present invention;

FIG. 16 is a view showing a method of outputting received 3D video data as a 2D image using 3D image format information according to a further embodiment of the present invention;

FIG. 17 is a view showing a 3D video data processing method using quincunx sampling according to an embodiment of the present invention;

FIG. 18 is a view showing an example of configuration of a broadcast receiver to convert a multiplexing format of a received image and output the converted image using 3D image format information according to an embodiment of the present invention;

FIG. 19 is a view showing a video data processing method of a broadcast receiver to convert a multiplexing format of a received image and output the converted image using 3D image format information according to an embodiment of the present invention;

FIG. 20 is a view illustrating an IPTV service search process in connection with the present invention;

FIG. 21 is a view illustrating an IPTV service SI table and a relationship among components thereof according to the present invention;

FIG. 22 is a view illustrating an example of a SourceReferenceType XML schema structure according to the present invention;

FIG. 23 is a view illustrating an example of a SourceType XML schema structure according to the present invention;

FIG. 24 is a view illustrating an example of a TypeOfSourceType XML schema structure according to the present invention;

FIG. 25 is a view illustrating an example of a StereoformatInformationType XML schema structure according to the present invention;

FIG. 26 is a view illustrating another example of a StereoformatInformationType XML schema structure according to the present invention;

FIG. 27 is a view illustrating an example of an IpSourceDefinitionType XML schema structure according to the present invention;

FIG. 28 is a view illustrating an example of an RfSourceDefinitionType XML schema structure according to the present invention;

FIG. 29 is a view illustrating an example of an IPService XML schema structure according to the present invention;

FIG. 30 is a view illustrating another example of a digital receiver to process a 3D service according to the present invention; and

FIG. 31 is a view illustrating a further example of a digital receiver to process a 3D service according to the present invention.

### BEST MODE

Reference will now be made in detail to the preferred embodiments of the present invention, examples of which are illustrated in the accompanying drawings. It should be noted herein that these embodiments are only for illustrative purposes and the protection scope of the invention is not limited or restricted thereto.

Terms used in this specification are general terms selected in consideration of function and widely used at the present time. However, such terms may vary depending upon intentions of those skilled in the art to which the present invention pertains, usual practices, or appearance of new technology. In a specific case, some terms may be selected by the applicant of the present application. In this case, meanings of such terms will be described in corresponding paragraphs of the specification. Therefore, it should be noted that terms used in this specification be interpreted based on real meanings of the terms and the disclosure of the present invention, not simple dictionary definition of the terms.

A 3-dimensional (3D) image processing method may include a stereoscopic image processing method considering two viewpoints and a multi view image processing method considering three or more viewpoints. On the other hand, a conventional single view image processing method may be referred to as a monoscopic image processing method.

In the stereoscopic image processing method, the same subject is captured by a left camera and a right camera, which are spaced apart from each other by a predetermined distance, and the captured left view image and right view image are used as an image pair. In the multi view image processing method, on the other hand, three or more images captured using three or more cameras disposed at predetermined intervals or angles are used. Hereinafter, the stereoscopic image processing method will be described as an example for easy understanding of the present invention and for the convenience of description; however, the present invention is not limited thereto. The present invention may be applied to the multi view image processing method. Hereinafter, the term ‘stereoscopic’ may also be simply referred to as ‘stereo’.

A stereoscopic image or a multi view image may be compression coded and transmitted using various methods including a Moving Picture Experts Group (MPEG).

For example, a stereoscopic image or a multi view image may be compression coded and transmitted using an H.264/AVC (Advanced Video Coding) method. At this time, a broadcast receiver may decode an image in a reverse order the H.264/AVC method to obtain a 3D image.

Also, one of a stereoscopic image, i.e. a left view image or a right view image of a stereoscopic image, or one of a multi view image may be assigned as a base layer image, and the other image may be assigned to an extended layer image or an enhanced layer image. The base layer image may be coded and transmitted in the same manner as a monoscopic image, and, for the extended layer image or the enhanced layer image, only relationship information between the base layer image and the extended layer image or the enhanced layer image may be coded and transmitted. JPEG, MPEG-2, MPEG-4, and H.264/AVC methods may be used as examples of compression coding methods for the base layer image. In the present invention, an H.264/AVC method is used as an example of the compression coding method. Also, an H.264/MVC(Multi-view Video Coding) method is used as an example of the compression coding method for an upper layer image.

Conventional terrestrial DTV transmission and reception standards are based on 2D video content. In order to provide 3DTV broadcast content, therefore, it is necessary to additionally define transmission and reception standards for 3D video content. A receiver may receive and properly process a broadcast signal according to the added transmission and reception standards to support a 3D broadcast service.

In the present invention, an Advanced Television Systems Committee (ATSC) system and a Digital Video Broadcasting (DVB) system will be described as an example of a DTV transmission and receiving system.

In the ATSC system and the DVB system, information to process broadcast content may be transmitted while being included in system information (SI). According to circumstances, the system information may be referred to as service information or signaling information. The system information includes, for example, channel information necessary for broadcasting, event information, service identification information, and format information for a 3D service. In the ATSC system, the system information may be transmitted and received while being included in a Program Specific Information/Program and System Information Protocol (PSI/PSIP). In the DVB system, on the other hand, the system information may be transmitted and received while being included in DVB-SI.

The PSI includes a Program Association Table (PAT) and a Program Map Table (PMT). The PAT is special information transmitted by a packet having a Packet ID (PID) of ‘0’. The PAT PID transmits information of a corresponding PMY for each program. The PMT transmits PID information of a Transport Stream (TS) packet, in which program identification numbers and individual bit streams, such as video and audio, constituting a program are transmitted, and PID information, in which a PCR is transmitted. A broadcast receiver may parse the PMT obtained from the PAT to acquire information regarding a correlation among components constituting a program.

The PSIP may include a Virtual Channel Table (VCT), a System Time Table (STT), a Rating Region Table (RRT), an Extended Text Table (ETT), a Direct Channel Table (DCCT), a Direct Channel Change Selection Code Table (DDCSCT), an Event Information Table (EIT), and a Master Guide Table (MGT). The VCT transmits information regarding a virtual channel, such as channel information for channel selection and a PID for audio and/or video reception. That is, the broadcast receiver may parse the VCT to acquire a PID of audio and video of a broadcast program carried in a channel together with channel name and channel number. The STT may transmit current data and time information, and the RRT may transmit information regarding a region and a counsel organization for program rating. The ETT may transmit additional description of a channel and a broadcast program, and the EIT may transmit information regarding an event. The DCCT/DDCSCT may transmit information regarding automatic channel change, and the MGT may transmit version and PID information of each table in the PSIP.

The DVB-SI may include a Service Description Table (SDT) and an Event Information Table (EIT). The SDT provides detailed information regarding a service, and the EIT provides detailed information regarding a program included in the service.

As will hereinafter be described, stereo format information, an L/R signal arrangement method, information regarding a view to be output in the first place during a 2D mode output, and information regarding reverse scanning of a specific view image with respect to an L/R image constituting a stereoscopic video elementary stream (ES) according to the present invention may be defined as the form of fields or descriptors of a newly defined table or the existing table in the above system information. In this specification, the information according to the present invention is described as being included in the PMT of the PSI, the TVCT of the PSIP, and the SDT of the DVB-SI; however, the present invention is not limited thereto. The above information may be defined based on another table and/or using an another method.

In the 3D broadcasting system, a left view image and a right view image may be transmitted while being multiplexed into one video stream for stereoscopic display. This may be referred to as stereoscopic video data or a stereoscopic video signal of an interim format. In order to receive and effectively output the stereoscopic video signal, in which left view video data and right view video data are multiplexed, through a broadcast channel, it is necessary to signal a corresponding 3D broadcast service in conventional broadcasting system standards.

In a case in which video data of two view images are transmitted while being reduced into half resolution in terms of spatial resolution and combined into one at a transmission end, the capacity of the video data of the two half resolution view images may be greater than that of video data of one full resolution view image. For efficient compression of data at the transmission end, therefore, the video data of the left view image or the video data of the right view image may be inverted to configure video data of two view images during mixing of the video data of the left view image and the video data of the right view image. In order for the broadcast receiver to effectively process these video data, therefore, it is necessary to signal information regarding video data configuration at the transmission end, for example, during video transmission as described above.

A stereoscopic image transmission format includes a single video stream format and a multi video stream format. The single video stream format is a mode to transmit two viewpoint video data while being multiplexed into a single video stream. The single video stream format has an advantage in that since the video data are transmitted through a signal video stream, additionally required bandwidth is not large in providing a 3D broadcast service. On the other hand, the multi video stream format is a mode to transmit plural video data through a plurality of video streams. The multi video stream format has an advantage in that since high-capacity data transmission is possible although the bandwidth is increased, it is possible to display high-quality video data.

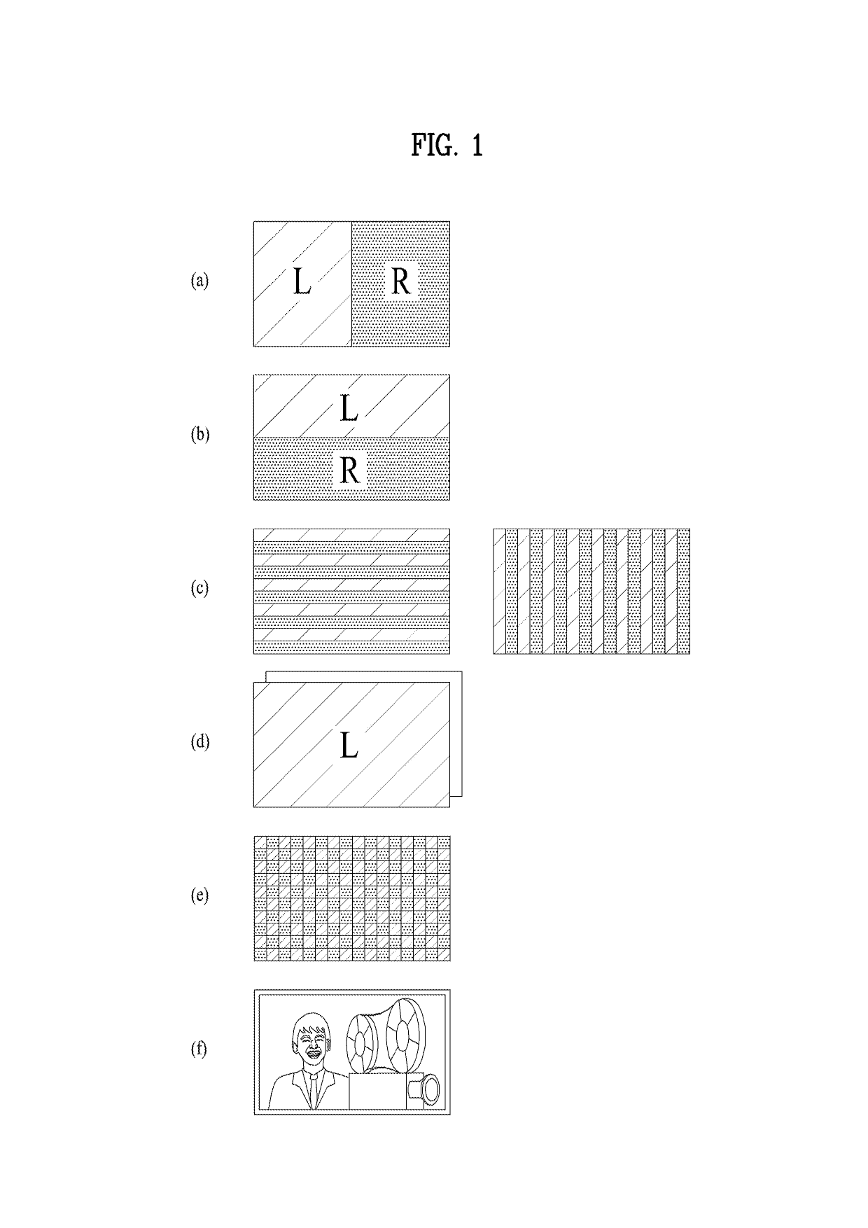

FIG. 1 is a view showing a stereoscopic image multiplexing format of a single video stream format.

The single video stream format includes a side-by-side format shown in FIG. 1(a), a top-bottom format shown in FIG. 1(b), an interlaced format shown in FIG. 1(c), a frame-sequential format shown in FIG. 1(d), a checker board format shown in FIG. 1(e), and an anaglyph format shown in FIG. 1(f).

In the side-by-side format shown in FIG. 1(a), a left view image and a right view image are ½ downsampled in the horizontal direction, and one of the sampled images is located at the left side and the other sampled image is located at the right side to configure a stereoscopic image. In the top-bottom format shown in FIG. 1(b), a left view image and a right view image are ½ downsampled in the vertical direction, and one of the sampled images is located at the top side and the other sampled image is located at the bottom side to configure a stereoscopic image. In the interlaced format shown in FIG. 1(c), a left view image and a right view image are ½ downsampled in the horizontal direction such that the left view image and the right view image intersect every line to configure one image, or a left view image and a right view image are ½ downsampled in the vertical direction such that the left view image and the right view image intersect every line to configure one image. In the frame-sequential format shown in FIG. 1(d), a left view image and a right view image intersect with the passage of time in a video stream to configure one image. In the checker board format shown in FIG. 1(e), a left view image and a right view image are ½ downsampled in the vertical direction and in the horizontal direction such that the left view image and the right view image intersect to configure one image. In the anaglyph format shown in FIG. 1(f), an image is configured to provide a stereoscopic effect using complementary color comparison.

In order for a broadcast receiver to effectively demultiplex and process video data transmitted in such various formats, it is necessary to transmit information regarding a multiplexing format at a transmission end.

Referring to FIG. 1, particularly in a case in which video data are transmitted in the side-by-side format and the top-bottom format, two ½ downsampled images are transmitted, and therefore, resolution of each image may be ½. In a case in which, however, the two images having half resolution are transmitted, the capacity of the video data may be greater than that of video data of one full resolution image. For example, in a case in which video data are coded such that the video data are different from a reference image, a video compression rate may be increased. This may occur when a video compression rate of two half resolution images is lower than that of one full resolution image. In a transmission system, therefore, one of the two images may be inverted up or down or mirrored left or right to increase a compression rate during transmission.

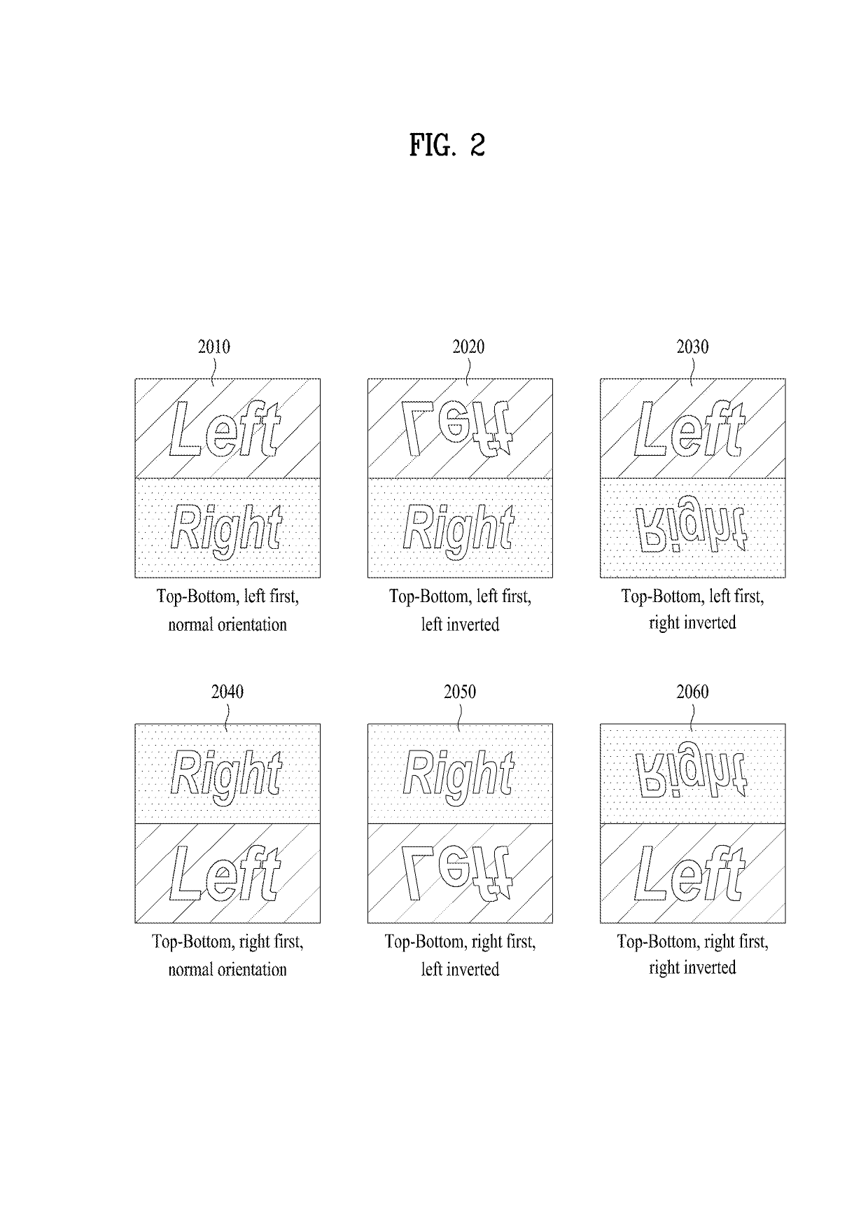

FIG. 2 is a view illustrating a method of a multiplexing a stereoscopic image in a top-bottom mode according to an embodiment of the present invention to configure an image.

Images 2010 to 2030 are configured such that a left view image is located at the top side and a right view image is located at the bottom side, and images 2040 to 2060 are configured such that a left view image is located at the bottom side and a right view image is located at the top side.

In the image 2010, the left view image located at the top side and the right view image located at the bottom side are normal. In the image 2020, the left view image located at the top side is inverted. In the image 2030, the right view image located at the bottom side is inverted.

In the image 2040, the left view image located at the bottom side and the right view image located at the top side are normal. In the image 2050, the left view image located at the bottom side is inverted. In the image 2060, the right view image located at the top side is inverted.

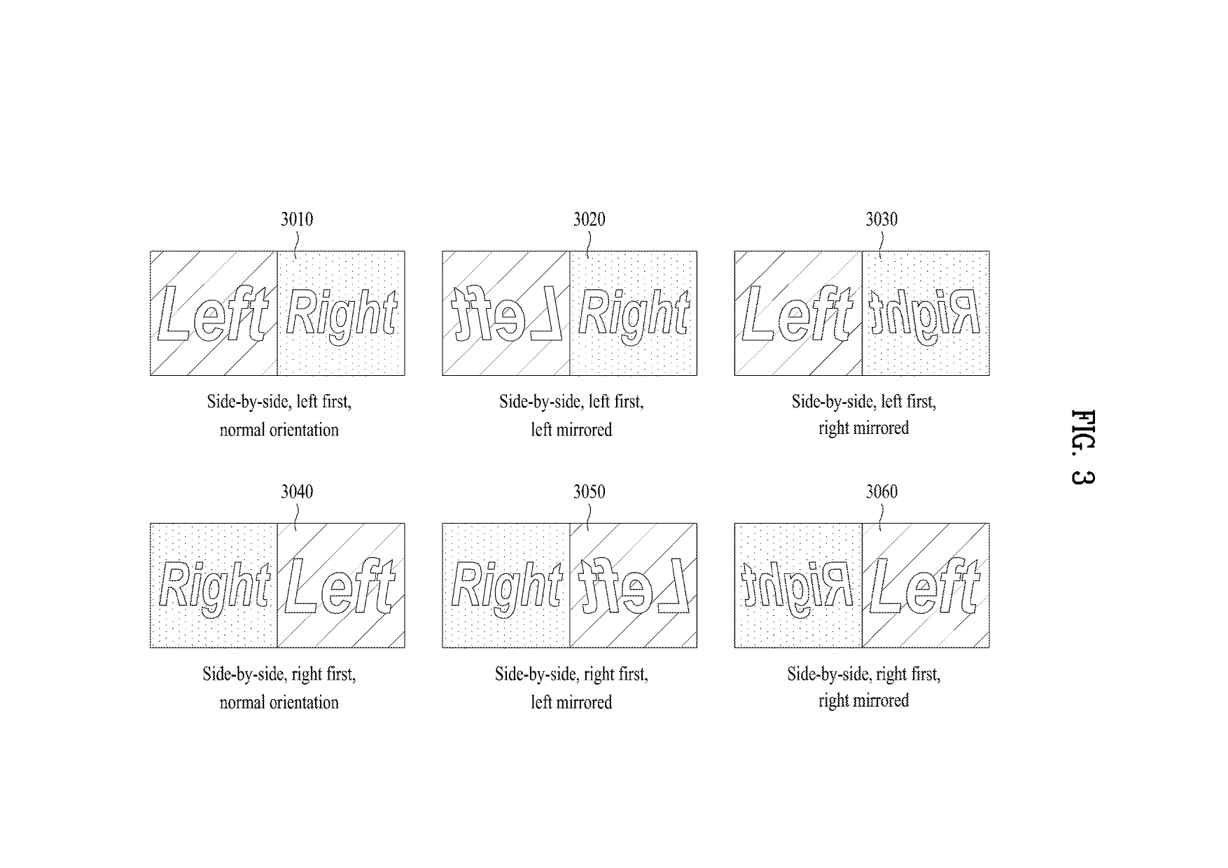

FIG. 3 is a view illustrating a method of a multiplexing a stereoscopic image in a side-by-side mode according to an embodiment of the present invention to configure an image

Images 3010 to 3030 are configured such that a left view image is located at the left side and a right view image is located at the right side, and images 3040 to 3060 are configured such that a left view image is located at the right side and a right view image is located at the left side.

In the image 3010, the left view image located at the left side and the right view image located at the right side are normal. In the image 3020, the left view image located at the left side is mirrored. In the image 3030, the right view image located at the right side is mirrored.

In the image 3040, the left view image located at the right side and the right view image located at the left side are normal. In the image 3050, the left view image located at the right side is mirrored. In the image 3060, the right view image located at the left side is mirrored.

The inverted and/or mirrored images as shown in FIGS. 2 and 3 may have different data compression rates. For example, it is assumed that data of surrounding pixels from a reference pixel of a screen are differentially compressed. A pair of stereoscopic images is basically an image pair exhibiting a 3D effect with respect to the same screen, and therefore, information based on screen positions may be similar. In other words, the normally arranged images 2010, 2040, 3010, and 3040, totally new image information may be connected and compressed differential values may be greatly changed at the interface between the left view image and the right view image. In the inverted images 2020, 2030, 2050, and 2060, however, the bottom side of the left view image may be connected to the bottom side of the right view image (2030 and 2050) or the top side of the left view image may be connected to the top side of the right view image (2020 and 2050) with the result that the amount of data coded at the interface between the left view image and the right view image may be reduced. In the mirrored images 3020, 3030, 3050, and 3060, on the other hand, the right side of the left view image may be connected to the right side of the right view image (3030 and 3050) or the left side of the left view image may be connected to the left side of the right view image (3020 and 3050) with the result that data similarity may be continuous at the interface between the left view image and the right view image, and therefore, the amount of coded data may be reduced.

In order for a broadcast receiver to receive and efficiently process a 3D video stream or 3D video data, it is necessary to know information regarding the above multiplexing format and information regarding inverting and/or minoring of an image.

Hereinafter, such information may be referred to as 3D image format information or stereo format information and may be defined as a table or a descriptor for the sake of convenience.

Hereinafter, the stereo format information according to the present invention transmitted while being included in the TVCT of the PSIP, the PMT of the PSI, and the SDT of the DVB-SI in the form of a descriptor as previously described will be described as an example. However, the stereo format information may also be defined as the form of a descriptor of another table, such as an EIT, in corresponding system information as well as the above table.

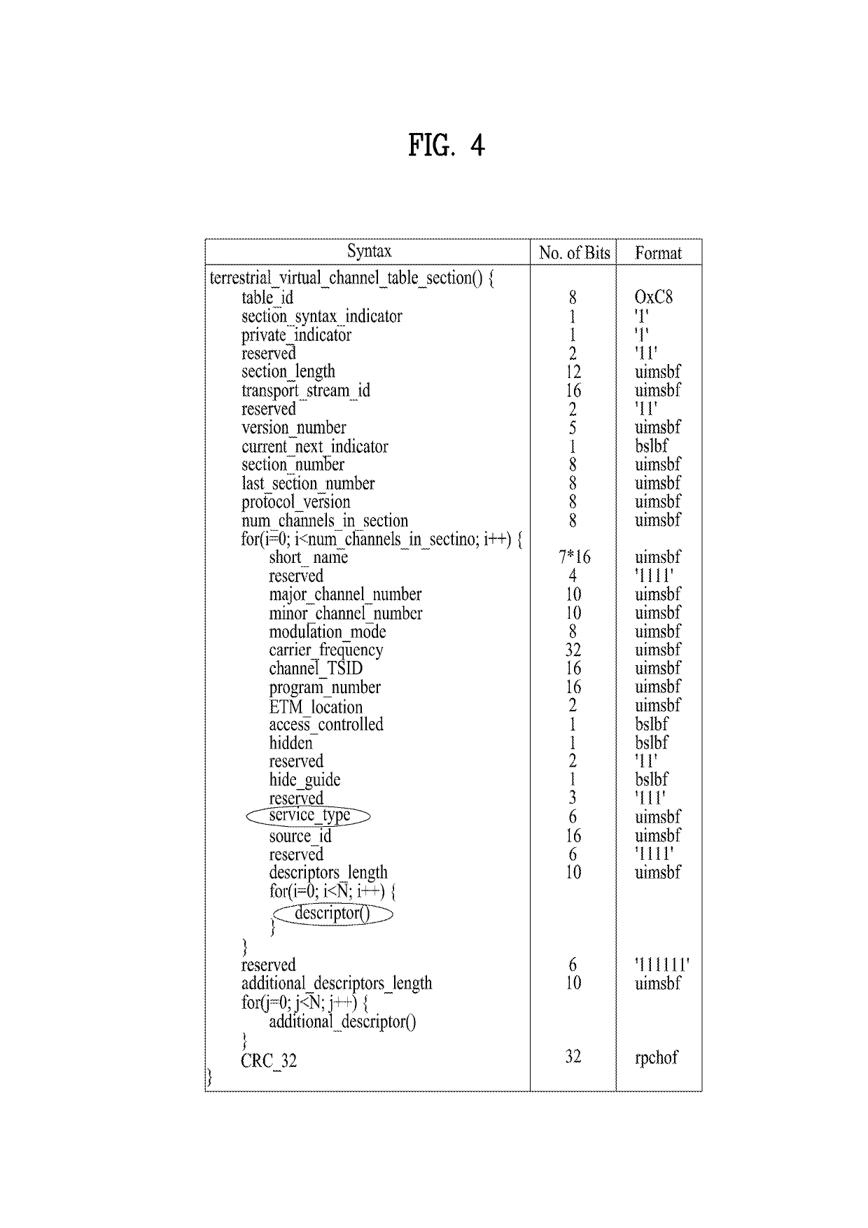

FIG. 4 is a view showing a syntax structure of a TVCT including stereo format information according to an embodiment of the present invention.

Fields included in TVCT table sections to basically provide attribute information of virtual channels will be described in detail with reference to FIG. 4.

A table_id field indicates type of table sections. For example, in a case in which corresponding table sections are table sections configuring the TVCT table, this field may have a value of 0xC8. A section_syntax_indicator field is composed of 1 bit and has a fixed value of 1. A private_indicator field is set to 1. A section_length field is composed of 12 bits, and the first two bits thereof are 00. The length of the section to a CRC field after this field is indicated by bytes. A transport_stream_id field is composed of 16 bits and indicates an MPEG-2 Transport stream (TS) ID. This TVCT may be distinguished from another TVCT by this field. A version_number field indicates a version of the table sections. Whenever a version is changed, the version_number field is incremented by 1, and, when the version value reaches 31, the next version value becomes 0. A current_next_indicator field is composed of 1 bit. When the VCT is currently applicable, this field is set to 1. If a value of this field is set to 0, it means that this field is not yet applicable, and the next field is available. A section_number field indicates the number of sections constituting the TVCT table. A last_section_number field indicates the last section constituting the TVCT table. A protocol_version field functions to allow a table kind different from that defined by the current protocol in future. In the current protocol, only 0 is a valid value. Values other than 0 will be used in a later version for a structurally different table.

A num_channels_in_section field indicates the number of virtual channels defined in the VCT table sections. Hereinafter, information regarding the corresponding channels will be defined in a loop form by the number of virtual channels defined in the num_channels_in_section field. Fields defined with respect to the corresponding channels in the loop form are as follows.

A short_name field indicates names of virtual channels.

A major_channel_number field indicates a major channel number of a corresponding virtual channel in a ‘for’ repetition sentence. Each virtual channel has multiple parts, such as a major channel number and a minor channel number. The major channel number functions as a reference number to a user for the corresponding virtual channel together with the minor channel number. A minor_channel_number field has a value of 0 to 999. The minor channel number functions as a two-part channel number together with the major channel number.

A modulation_mode field indicates a modulation mode of a transmission carrier related to a corresponding virtual channel.

A carrier_frequency field may indicate a carrier frequency.

A channel_TSID field has a value of 0x0000 to 0xFFFF. This channel is an MPEG-2 TSID related to a TS transmitting an MPEG-2 program referred to by this virtual channel.

A program_number field correlates a virtual channel defined in the TVCT with a Program Association Table (PAT) and a Program Map Table (PMT) of MPEG-2.

An ETM_location field indicates the presence and location of an Extended Text Message (ETM).

An access_controlled field is a flag field. In a case in which this field is 1, it may indicate that an event related to a corresponding virtual channel is access controlled. In a case in which this field is 0, it may indicate that access is not limited.

A hidden field is a flag field. In a case in which this field is 1, access is not allowed although a user directly inputs a corresponding number. A hidden virtual channel is skipped when the user performs channel surfing, and it appears as if the hidden virtual channel is not defined.

A hide_guide field is a flag field. In a case in which this field is set to 1 for a hidden channel, a virtual channel and an event thereof may be display on an EPG display. In a case in which a hidden bit is not set, this field is ignored. Consequently, a non-hidden channel and an event thereof are displayed on the EPG display irrespective of status of the hide_guide field.

A service_type field identifies type of a service transmitted through a corresponding virtual channel. In particular, the service_type field may identify whether type of a service provided through a corresponding channel is a 3D service when a 3D stereoscopic service according to the present invention is provided as previously described. For example, in a case in which a value of this field is 0x13, the broadcast receive may indentify that a service provided through a corresponding channel is a 3D service from the value of this field.

A source_id field identifies a programming source related to a virtual channel. The source may be any one selected from among video, text, data, or audio programming. The source_id field has a value of 0, which is reserved. From 0x0001 to 0x0FFF, the source_id field has a unique value in a TS transmitting a VCT. Also, the source_id field has a unique value in a region level from 0x1000 to 0xFFFF.

A descriptors_length field indicates the length of following descriptors for a corresponding virtual channel in bytes.

No descriptor may be included in descriptor( ) or one or more descriptors may be included in descriptor( ). This descriptor( ) field may include a stereo_format_descriptor related to a 3D stereoscopic service according to the present invention, as will hereinafter be described.

A additional_descriptors_length field indicates the total length of a following VCT descriptor list in bytes.

A CRC_{—}32 field indicates a Cyclic Redundancy Check (CRC) value, by which a register in the decoder has a zero output.

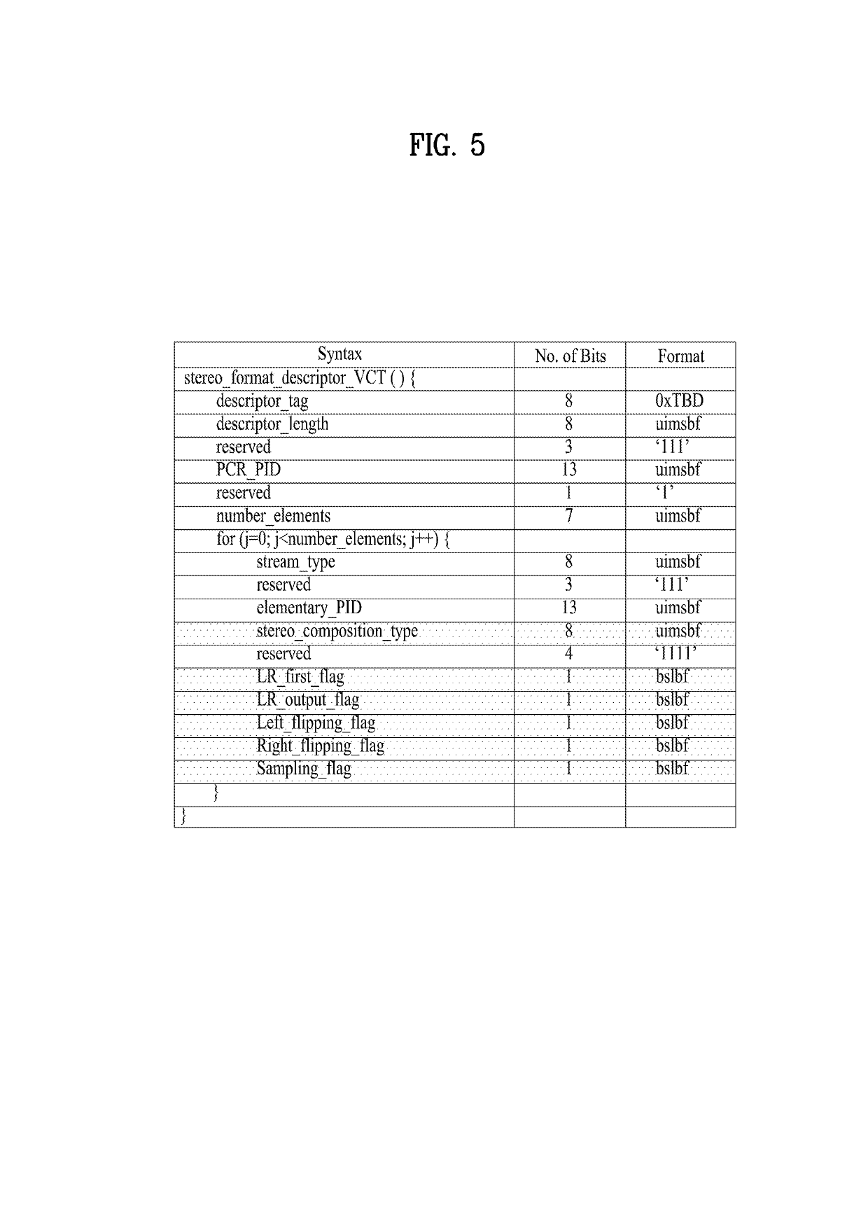

FIG. 5 is a view illustrating a syntax structure of a stereo format descriptor included in TVCT table sections according to an embodiment of the present invention

A descriptor_tag field is a field to identify a corresponding descriptor and may have a value indicating that the corresponding descriptor is a stereo_format_descriptor.

A descriptor_length field provides information regarding the length of a corresponding descriptor.

A number_elements field indicates the number of video elements constituting a corresponding virtual channel. The broadcast receiver may receive a stereo format descriptor to parse information included in the following fields by the number of video elements constituting a corresponding virtual channel.

A Stream_type field indicates stream type of video elements.

An elementary_PID field indicates PIDs of corresponding video elements. The stereo format descriptor defines the following information regarding video elements having PIDs of the elementary_PID field. The broadcast receiver may acquire information for 3D video display of video elements having corresponding PIDs from the stereo format descriptor.

A stereo_composition_type field is a field indicating a format to multiplex a stereoscopic image. The broadcast receiver may parse the stereo_composition_type field to decide in which multiplexing format, which is selected from among a side-by-side format, a top-bottom format, an interlaced format, a frame-sequential format, a checker board format, and an anaglyph format, a corresponding 3D image has been transmitted.

An LR_first_flag field indicates whether the leftmost uppermost pixel is a left view image or a right view image when a stereoscopic image is multiplexed. In an embodiment, in a case in which a left view image is located at the left upper end, a field value may be set to ‘0’. On the other hand, in a case in which a right view image is located at the left upper end, a field value may be set to ‘1’. For example, the broadcast receiver may know that the received 3D image has been received in the side-by-side type multiplexing format through the stereo_composition_type and identify that the left half image of one frame corresponds to a left view image and the right half image of the frame corresponds to a right view image in a case in which a value of the LR_first_flag field is ‘0’.

An LR_output_flag field is a field indicating a recommended output view with respect to an application to output only one of the stereoscopic images for compatibility with a 2D broadcast receiver. In an embodiment, when a 2D image is output, a left view image may be output if a field value is ‘0’ and a right view image may be output if a field value is ‘1’. The LR_output_flag field may be ignored according to user setting. If there is no user input related to an output image, however, a default view image used for 2D output may be displayed. For example, in a case in which a value of the LR_output_flag field is ‘1’, the broadcast receiver uses the right view image as 2D output as long as there is no other user setting or input.

A left_flipping_flag field and a right_flipping_flag field indicate scanning directions of a left view image and a right view image, respectively. In a transmission system, the left view image or the right view image may be scanned in the reverse direction in consideration of compression efficiency during coding.

The transmission system may transmit a stereoscopic image in the top-bottom format or the side-by-side format as described with reference to FIGS. 2 and 3. In the top-bottom format, one image may be inverted to the top side or the bottom side. In the side-by-side format, one image may be mirrored to the left side or the right side. In a case in which the image is inverted to the top side or the bottom side or mirrored to the left side or the right side as described above, the broadcast receiver may parse the left_flipping_flag field to determine scanning directions. In an embodiment, in a case in which a field value of the left_flipping_flag field and the right_flipping_flag field is ‘0’, this may indicate that pixels of the left view image and the right view image are arranged in the original scanning directions. On the other hand, in a case in which a field value of the left_flipping_flag field and the right_flipping_flag field is ‘1’, this may indicate that pixels of the left view image and the right view image are arranged in directions reverse to the original scanning directions.

As described above, the scanning direction in the top-bottom format is a reverse direction in the vertical direction, and the scanning direction in the side-by-side format is a reverse direction in the horizontal direction. According to an embodiment in which the broadcast receiver is realized, the left_flipping_flag field and the right_flipping_flag field are ignored for other multiplexing formats excluding the top-bottom format and the side-by-side format. That is, the broadcast receiver may parse the stereo_composition_type field to determine a multiplexing format. Upon determining that the multiplexing format is a top-bottom format or a side-by-side format, the broadcast receiver may parse the left_flipping_flag field and the right_flipping_flag field to decide scanning directions. Upon determining that the multiplexing format is a format other than the top-bottom format or the side-by-side format, on the other hand, the broadcast receiver may ignore the left_flipping_flag field and the right_flipping_flag field. In another embodiment in which the broadcast receiver is realized, image may be configured in the reverse directions even in a multiplexing format other than the top-bottom format or the side-by-side format. In this case, the canning directions may be decided through the left_flipping_flag field and the right_flipping_flag field.

A sampling_flag field indicates whether sampling has been performed in a case in which a full resolution image has been sampled to a half resolution image in the transmission system. In an embodiment, the transmission system may perform 1/2 downsampling (or ½ decimation) in the horizontal direction or in the vertical direction and ½ downsampling (quincunx sampling or quincunx filtering) in the diagonal direction using a quincunx filter having the same form as the checker board format. In an embodiment, in a case in which a field value of the sampling_flag field is ‘1’, this may indicate that the transmission system has performed ½ downsampling in the horizontal direction or in the vertical direction. On the other hand, in a case in which a field value of the sampling_flag field is ‘0’, this may indicate that the transmission system has performed downsampling using the quincunx filter. In a case in which a field value of the sampling_flag field is ‘1’, the broadcast receiver may perform a reverse procedure of the quincunx filtering to restore an image.

For example, in a case in which the respective fields of the stereo format descriptor have the following field values: the stereo_composition_type=‘side-by-side’, the LR_first_flag=‘1’, the left_flipping_flag=‘1’, and the right_flipping_flag=‘0’, this may indicate that a video stream is multiplexed in a side-by-side format, a right view image is located at the left side, and a left view image is mirrored. Consequently, the broadcast receiver scans the left view image in the reverse direction before display to configure an output screen. In a case in which sampling_flag=‘1’, this may indicate that quincunx sampling has been performed, and the broadcast receiver may perform proper formatting through quincunx reverse-sampling to configure an output screen.

In a case in which a user wishes to view an image in a 2D mode or a display device does not support a 3D display, the broadcast receiver may output one view image designated by the LR_output_flag field as default. At this time, the other view image may be bypassed without outputting. In this procedure, the broadcast receiver may scan the image in the reverse direction in consideration of the left_flipping_flag field and the right_flipping_flag field.

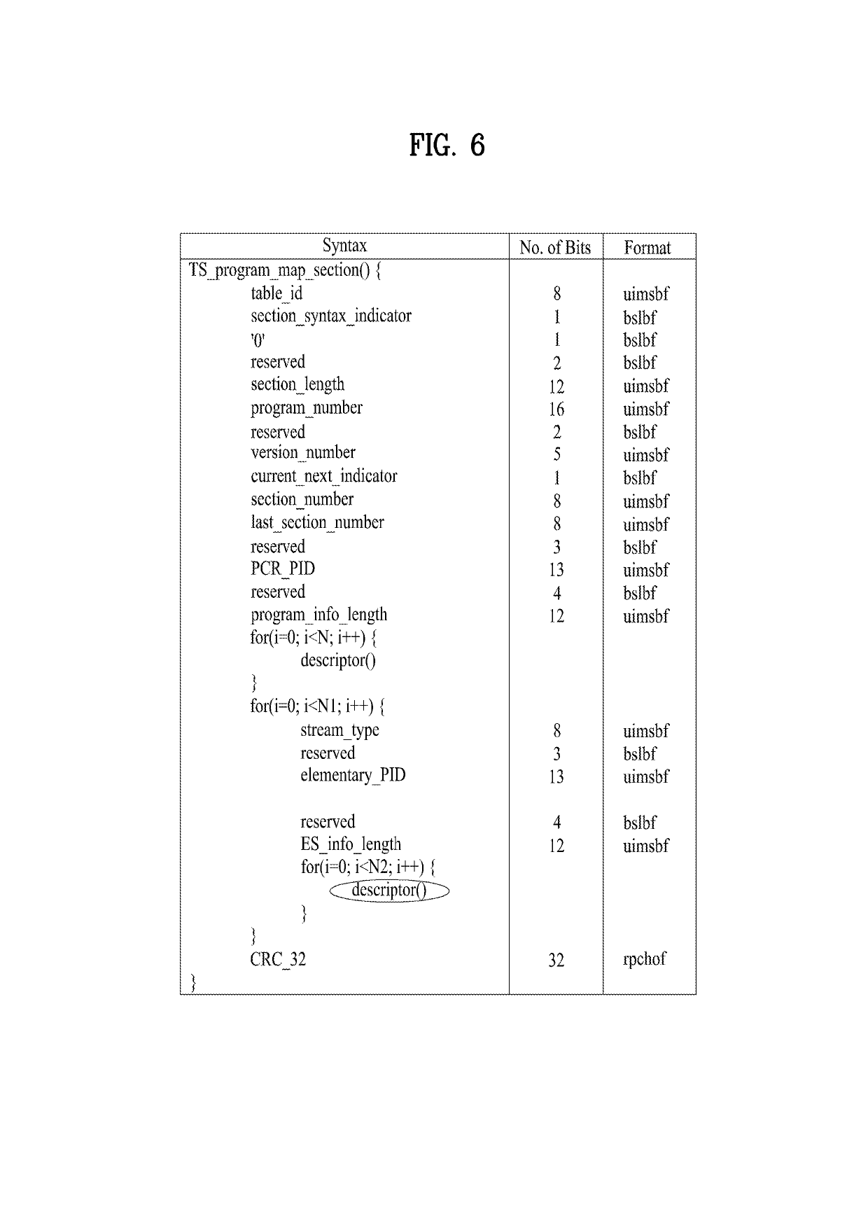

FIG. 6 is a view illustrating a syntax structure of a PMT including stereo format information according to an embodiment of the present invention

Hereinafter, fields included in PMT table sections will be described in detail with reference to FIG. 6.

A table_id field is a table identifier. An identifier to identify the PMT may be set.

A section_syntax_indicator field is an indicator to define section type of the PMT.

A section_length field indicates the section length of the PMT.

A program_number field indicates program number as information coinciding with a PAT.

A version_number field indicates version number of the PMT.

A current_next_indicator field is an identifier to indicate whether the current table section is applicable.

A section_number field indicates section number of the current PMT section in a case in which the PCT is transmitted while being divided into one or more sections.

A last_section_number field indicates last section number of the PMT.

A PCR_PID field indicates a PID of a packet transmitting program clock reference (PCR) of the current program.

A program_info_length field indicates length information of a descriptor immediately following the program_info_length field in bytes. That is, the program_info_length field indicates the length of descriptors included in a first loop.

A stream_type field indicates kind and coding information of an elementary stream contained in a packet having a PID value indicated in the following elementary_PID field.

An elementary_PID field indicates identifier of the elementary stream, i.e. a PID value of a packet, in which a corresponding elementary stream is included.

An ES_Info_length field indicates length information of a descriptor immediately following the ES_Info_length field in bytes. That is, the program_info_length field indicates the length of descriptors included in a second loop.

Program level descriptors are included in a descriptor( ) region of the first loop of the PMT, and stream level descriptors are included in a descriptor( ) region of the second loop of the PMT.

According to the present invention, in a case in which a program corresponding to a value of the program_number field of the PMT is 3D content, identification information to confirm reception of a 3D image is included in the descriptor( ) region of the first loop of the PMT in the form of a descriptor as an embodiment. In the present invention, this descriptor may be referred to as an image format descriptor Stereo_Format_descriptor( ).

That is, when the PMT is received while the image format descriptor is included in the PMT, the broadcast receive determines that a program corresponding to the program information of the PMT is 3D content.

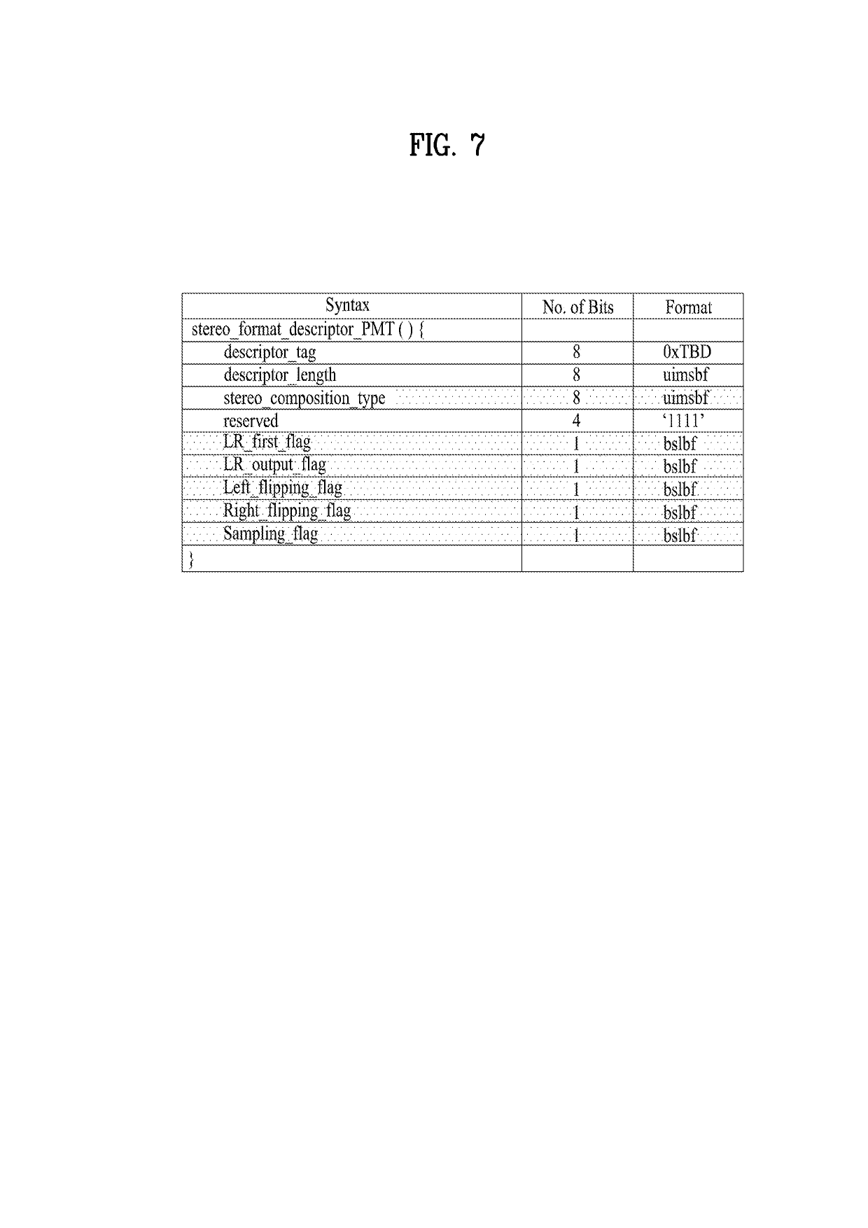

FIG. 7 is a view illustrating a syntax structure of a stereo format descriptor included in a PMT according to an embodiment of the present invention.

The stereo format descriptor of FIG. 7 is similar to the stereo format descriptor of FIG. 5, and a detailed description of fields identical to those of FIG. 5 will be omitted. In case of the PMT, however, information regarding a stream_type field and an elementary_PID for a video element is included in the PMT unlike FIG. 5. These fields were previously described with reference to FIG. 5.

The above description is related to, for example, the ATSC system. On the other hand, definition may be slightly different in a DVB system. Hereinafter, the DVB system will be described in more detail. However, a detailed description of features identical to what has been given above will be omitted.

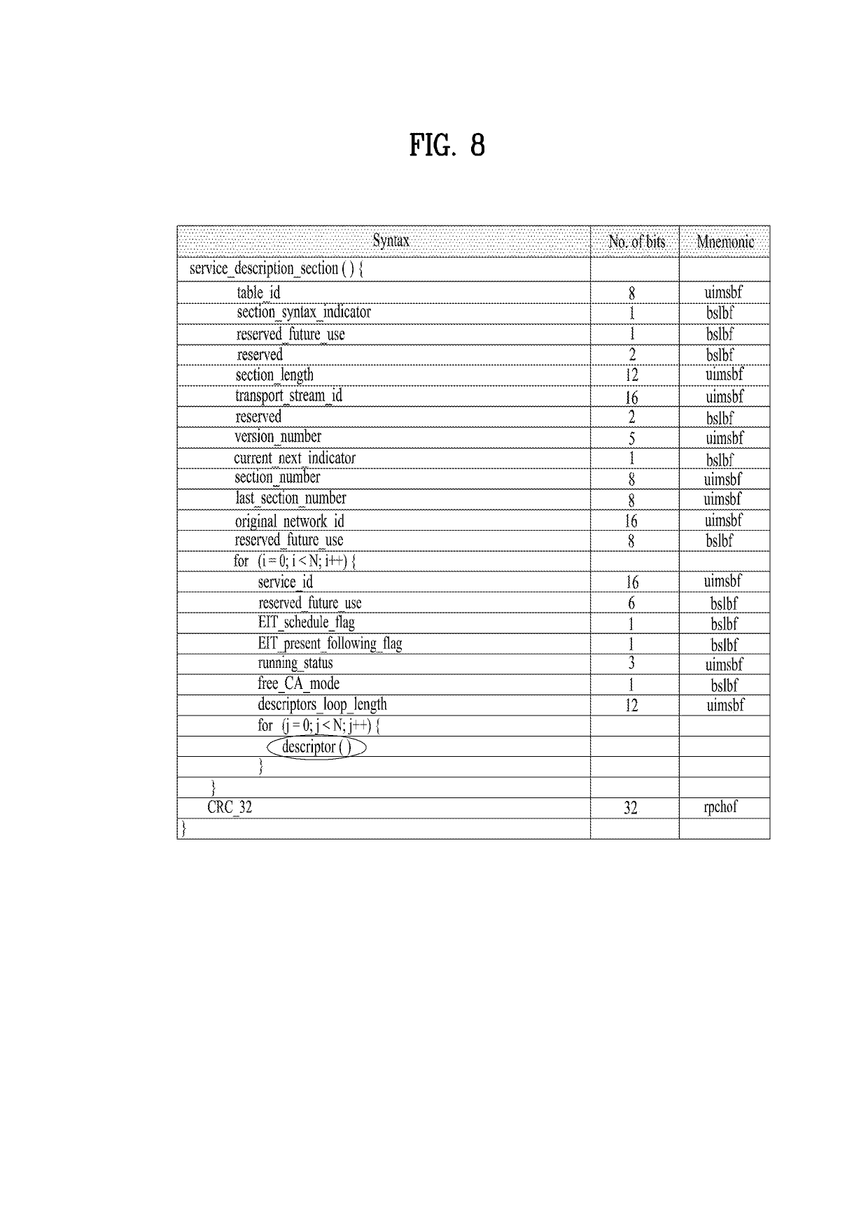

FIG. 8 is a view illustrating a bitstream syntax structure of SDT table sections according to an embodiment of the present invention.

The SDT describes services included in a specific transport stream in the DVB system.

Hereinafter, respective fields in the SDT table sections will be described in more detail with reference to FIG. 8.

A table_id field is an identifier to identify a table. For example, a specific value of the table_id field indicates that this section belongs to a service description table.

A section_syntax_indicator field is a 1 bit field and is set to 1.

First two bits of a section_length field are set to 00. Byte number of a section including a CRC is indicated after this field. A transport_stream_id field serves as a label to distinguish Transport Stream (TS). A version_number field indicates a version number of sub_table. Whenever a version number of sub_table is changed, the number of version_number field is increased by 1. A value of a current_next_indicator field is set to 1 when the sub_table is currently applicable. If a value of this field is set to 0, this means that this field is not yet applicable, and the next field is available. A section_number field indicates section number. The first section has a value of 0x00, and the value is incremented by 1 for each section having the same table_id, the same transport_stream_id, and the same original_network_id. A last_section_number field indicates the number of the last section (that is, the highest section number) of a corresponding sub_table, which is a portion of this section.

An original_network_id field is a label to identify a network_id of the transmission system. This SDT table sections describe a plurality of services. The respect services are signaled using the following fields.

A service_id field defines an identifier serving as a label to distinguish between services included in the TS. This field may have the same value as, for example, program_number of program_map_section.

In a case in which an EIT_schedule_flag field is set to 1, this indicates that EIT schedule information for a corresponding service is included in the current TS. On the other hand, in a case in which a field of this field is 0, this indicates that EIT schedule information is not included in the current TS.

In a case in which an EIT_present_following_flag field is set to 1, it indicates that EIT_present_following information for a corresponding service is included in the current TS. On the other hand, in a case in which a field of this field is 0, this indicates that EIT present/following is not included in the current TS.

A running_status field indicates status of a service.

In a case in which a free_CA_mode field is set to 0, it indicates that all elementary streams of a corresponding service are not scrambled. On the other hand, in a case in which the free_CA_mode field is set to 1, this indicates one or more streams are controlled by a Conditional Access (CA) system.

A descriptors_loop_length field indicates the total length of following descriptors in bytes.

A CRC_{—}32 field indicates a CRC value, by which a register in the decoder has a zero output.

According to an embodiment of the present invention, it may be indicated that this service is a 3D broadcast service in a descriptor region following the descriptors_loop_length field through a service_type field included in a Service Descriptor of a DVB SI.

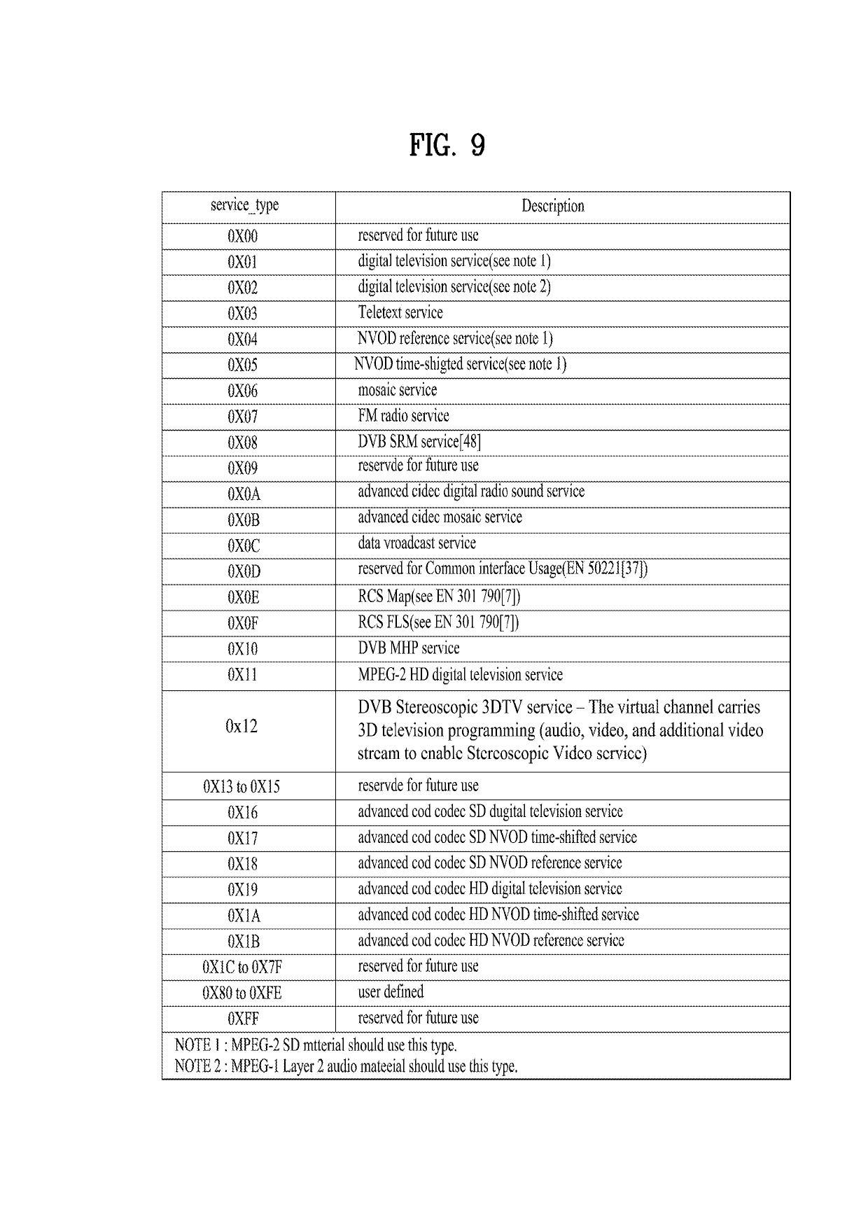

FIG. 9 is a view illustrating an example of configuration of a service_type field according to the present invention

The service_type field of FIG. 9 is defined in a service_descriptor transmitted while being included in, for example, the SDT table sections of FIG. 8.

In connection with the present invention, in a case in which a value of the service_type field is 0x12, it may indicate a 3D stereoscopic service.

Referring to FIG. 9, services may be configured as follows in consideration of linkage between a 2D service and a 3D service and compatibility with an existing receiver.

A 2D service and a 3D service are respectively defined and used. In this case, a service type for the 3D service may use the above value. Linkage between the two services may be achieved through, for example, a linkage descriptor. In this case, additional stream_content and component_type values may be assigned to an elementary stream (ES) for 3D. As a result, the existing receiver may not recognize and ignore it such that the existing receiver provides a service without difficulty using a stream for a base service.

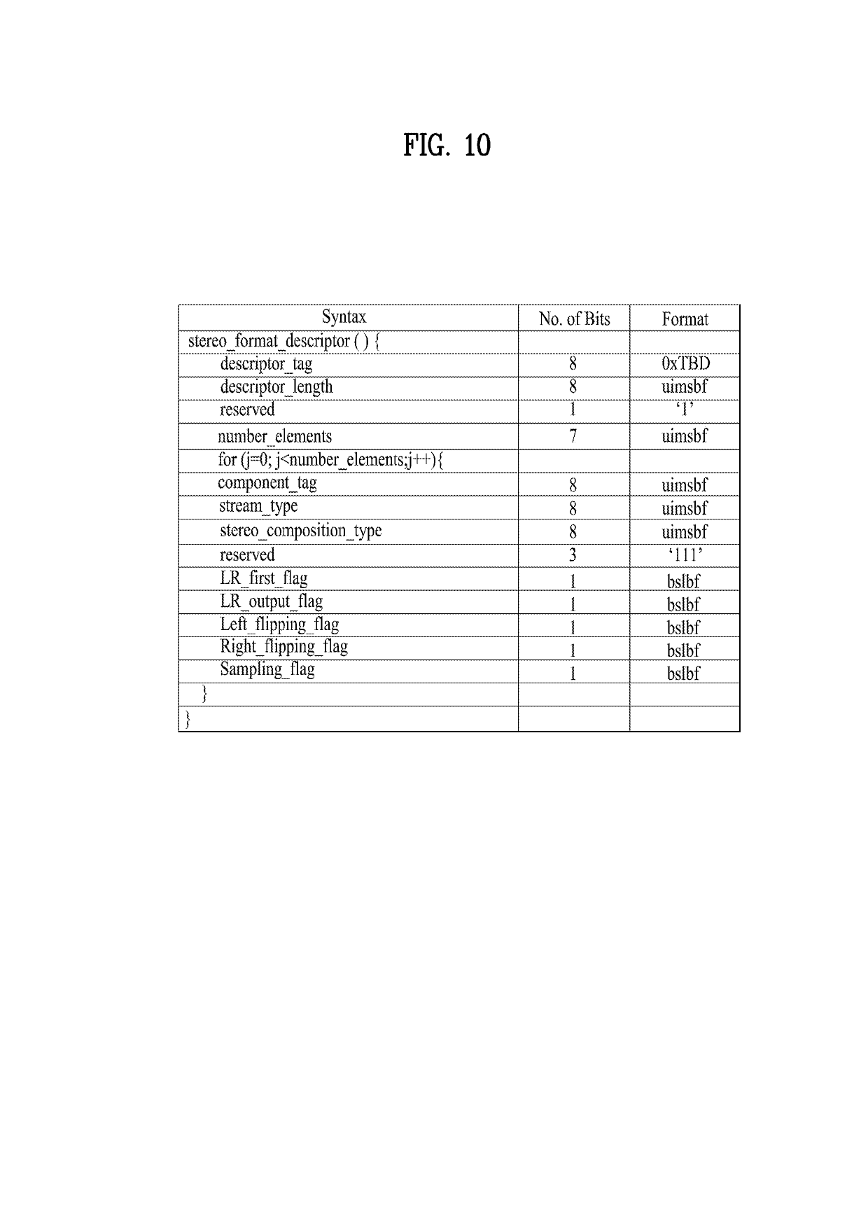

FIG. 10 is a view illustrating a syntax structure of a stereo format descriptor included in an SD according to an embodiment of the present invention.

The bitstream syntax structure of the stereo format descriptor of FIG. 10 may have the same structure as, for example, the stereo format descriptor of FIG. 5, and therefore, a detailed description of fields identical to those of FIG. 5 will be omitted.

The stereo format descriptor of FIG. 10 may be defined as, for example, a descriptor of an EIT although not shown. In this case, some fields may be omitted from or added to the bitstream syntax structure according to the characteristics of the EIT.

The broadcast receiver may transmit a broadcast signal including a 3D image. To this end, the broadcast receiver may include a 3D image pre-processor to perform image processing with respect to 3D images, a video formatter to process the 3D image and to format 3D video data or 3D video stream, a 3D video encoder to encode the 3D video data using an MPEG-2 method, an SI processor to generate system information, a TS multiplexer to multiplex video data and system information, and a transmission unit to transmit the multiplexed broadcast signal. According to embodiments, however, the transmission unit may further include a VSB/OFDM encoder and a modulator.

A 3D video data processing method of the broadcast receiver is performed as follows.

First, the 3D image pre-processor perform necessary processing with respect to 3D images photographed using a plurality of lenses to output a plurality of 3D images or video data. In an embodiment, in a case in which a 3D broadcast service is provided using a stereoscopic method, images or video data for two viewpoints are output.

The broadcast receiver formats the stereo video data using the video formatter. In an embodiment, the broadcast receiver may resize and multiplex the stereo video data according to a multiplexing format to output the stereo video data as a single video stream. The video formatting of the stereo video data includes various image processes (for example, resizing, decimation, interpolating, multiplexing, etc.) necessary to transmit a 3D broadcast signal

The broadcast receiver encodes the stereo video data using the 3D video encoder. In an embodiment, the broadcast receiver may encode the stereo video data using JPEG, MPEG-2, MPEG-4, H.264/AVC, and H.264/MVC methods.

The broadcast receiver generates system information including 3D image format information using the SI processor. The 3D image format information is information used for the transmitter to format the stereo video data. The 3D image format information includes information necessary for the receiver to process and output the stereo video data. In an embodiment, the 3D image format information may include a multiplexing format of 3D video data, positions and scanning directions of a left view image and a right view image according to the multiplexing format, and sampling information according to the multiplexing format. In an embodiment, the 3D image format information may be included in a PSI/PSIP of the system information. Also, the 3D image format information may be included in a PMT of the PSI and a VCT of the PSIP.

The broadcast receiver may multiplex the stereo video data encoded by the 3D video encoder and the system information generated by the SI processor using the TS multiplexer and transmit the stereo video data and the system information through the transmission unit.

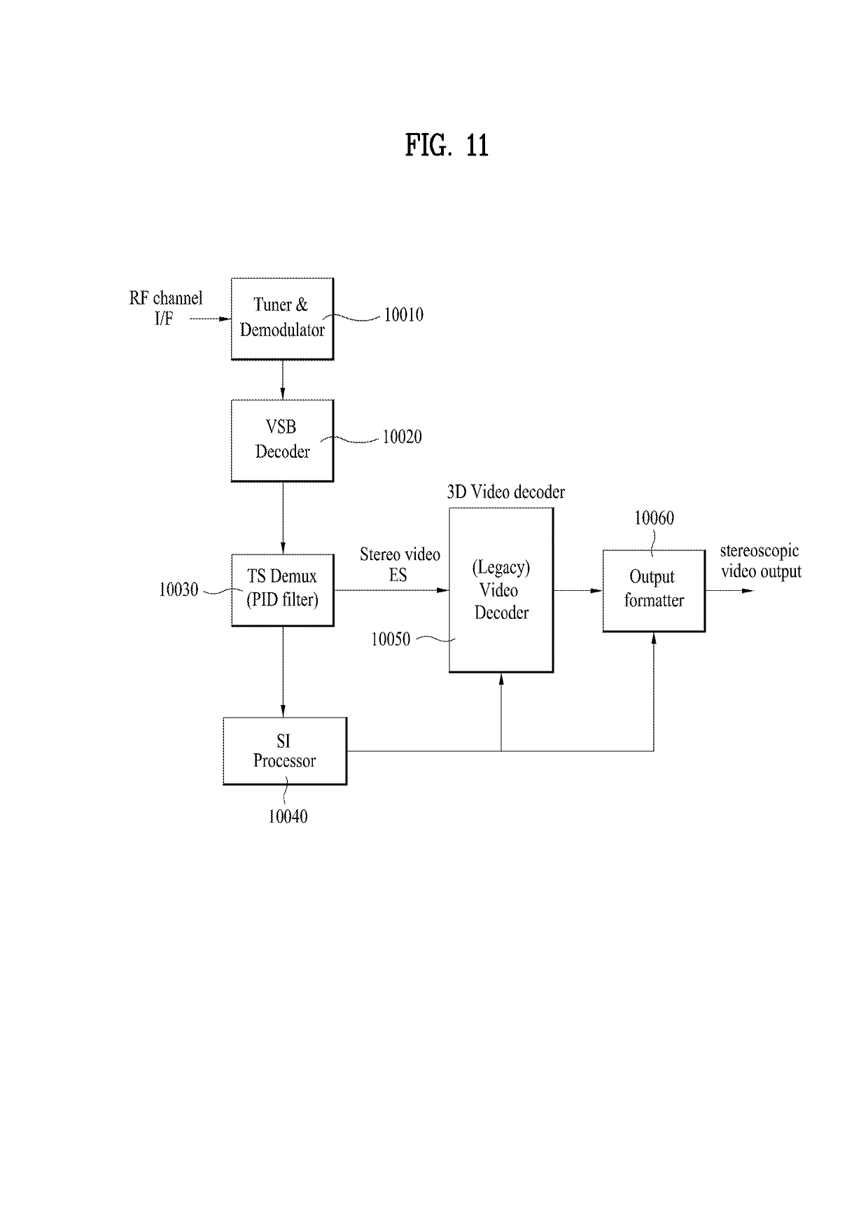

FIG. 11 is a view illustrating a broadcast receiver according to an embodiment of the present invention.

The broadcast receiver of FIG. 11 includes a receiving unit to receive a broadcast signal, a TS demultiplexer 10030 to extract and output data streams, such as video data and system information, from the broadcast signal, an SI processor 10040 to parse the system information, a 3D video decoder 10050 to decode 3D video data, and an output formatter 10060 to format and output the decoded 3D video data. According to embodiments, the receiving unit may further include a tuner and demodulator 10010 and a VSB/OFDM decoder 10020. The operation of the respective structural elements of the broadcast receiver will hereinafter be described with reference to the drawings.

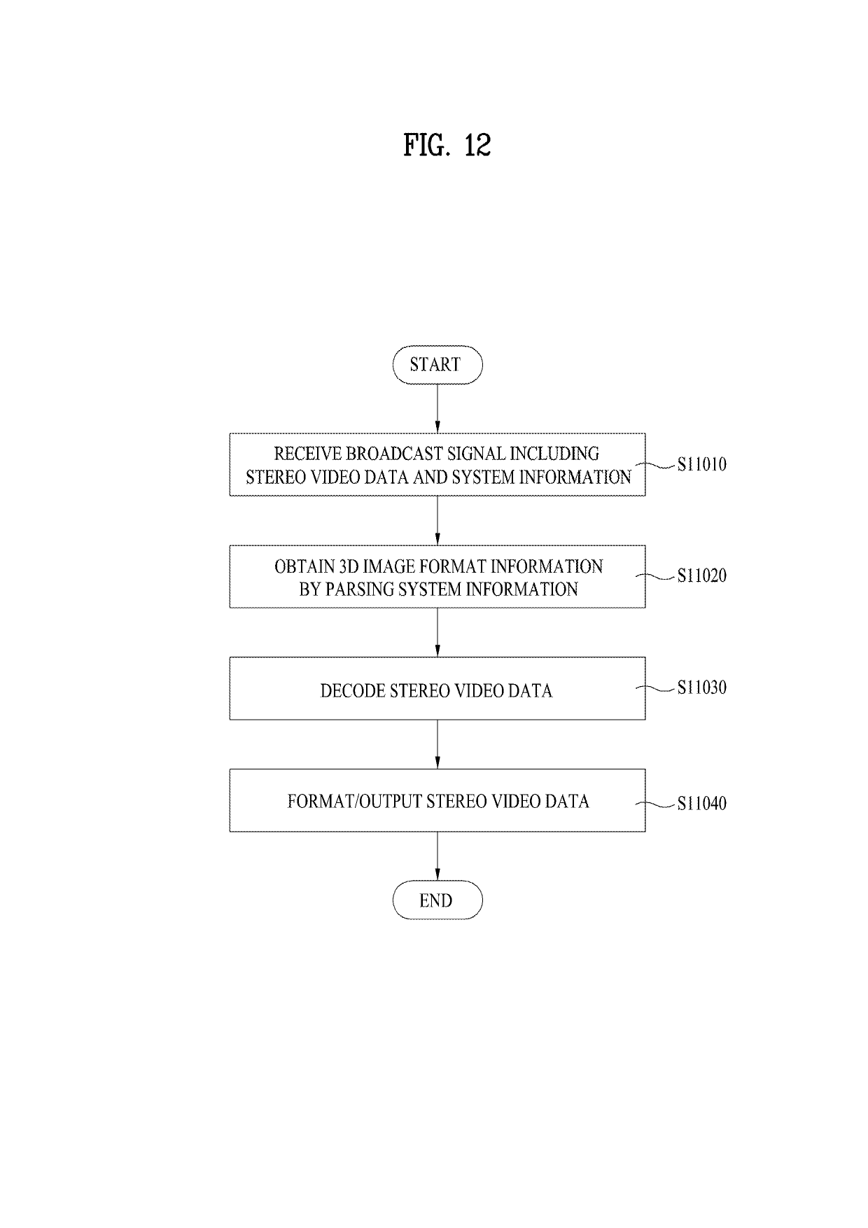

FIG. 12 is a flowchart showing a 3D video data processing method of a broadcast receiver according to an embodiment of the present invention

The broadcast receiver receives a broadcast signal including stereo video data and system information using the receiving unit (S11010).

The broadcast receiver parses the system information included in the broadcast signal using the SI processor 10040 to acquire 3D image format information (S11020). In an embodiment, the broadcast receiver may parse any one selected from among the PMT of the PSI, the TVCT of the PSIP, and the SDT of the DVB-SI using the SI processor 10040 to acquire stereo format information. The stereo format information includes information necessary for the decoder 11050 and the output formatter 10060 of the broadcast receiver to process the 3D video data. In an embodiment, the stereo format information may include a multiplexing format of 3D video data, positions and scanning directions of a left view image and a right view image according to the multiplexing format, and sampling information according to the multiplexing format.

The broadcast receiver decodes the stereo video data using the 3D video decoder (S10030). At this time, the broadcast receiver may decode the stereo video data using the acquired stereo format information.

Subsequently, the broadcast receiver formats and outputs the decoded stereo video data using the output formatter 10060 (S10040). Formatting of the stereo video data includes processing the received stereo video data using the stereo format information. Also, in a case in which the multiplexing format of the received stereo video data does not coincide with a multiplexing format supported by a display device and in a case in which video data output modes are different (2D output or 3D output), a necessary image processing may be performed.

Hereinafter, formatting of the stereo video data in the broadcast receiver will be described in detail.

First, the operation of the broadcast receiver in a case in which the stereo format information is acquired from the TVCT, the PMT, and the SDT will be described.

(1) A case in which the 3D image format information is received through the TVCT

The broadcast receiver may determine whether a 3D broadcast service is provided through a corresponding virtual channel using the service_type field of the TVCT. Upon determining that the 3D broadcast service is provided, the broadcast receiver receives elementary_PID information of a 3D stereo video using stereo format information (stereo format descriptor) and receives and extracts 3D video data corresponding to the PID. Also, the broadcast receiver checks stereoscopic image configuration information regarding the 3D video data and information regarding left/right disposition, left/right priority output, left/right reverse scanning, and resizing using the stereo format information.

a) In a case in which an image is viewed in a 2D mode, the 3D video data are decoded to extract only video data corresponding to a view designated by the LR_output_flag, interpolation/resizing is performed with respect to the extracted video data, and the interpolated/resized video data are output to the display device.

b) In a case in which an image is viewed in a 3D mode, the 3D video data are decoded, and display output is controlled using the stereo format information. In this procedure, resizing, reshaping, and 3D conversion are performed according to type of the display device to output a stereoscopic image.

(2) A case in which the 3D image format information is received through the PMT

The broadcast receiver checks the presence of stereo format information (stereo format descriptor) corresponding to stream_type of the PMT and each elementary stream (ES). At this time, the broadcast receiver may determine whether a corresponding program provides a 3D broadcast service through the presence of the stereo format information. In a case in which the 3D broadcast service is provided, the broadcast receiver acquires a PID corresponding to 3D video data, and receives and extracts 3D video data corresponding to the PID.

The broadcast receiver may acquire stereoscopic image configuration information regarding the 3D video data and information regarding left/right disposition, left/right priority output, left/right reverse scanning, and resizing through the stereo format information.

The broadcast receiver performs mapping with information provided through the TVCT through the program_number field. Alternatively, the broadcast receiver performs mapping with the service_id field of the SDT through the program_number field (it can be seen through which virtual channel or service this program is provided).

a) In a case in which an image is viewed in a 2D mode, the 3D video data are decoded to extract only video data corresponding to a view designated by the LR_output_flag, interpolation/resizing is performed with respect to the extracted video data, and the interpolated/resized video data are output to the display device.

b) In a case in which an image is viewed in a 3D mode, the 3D video data are decoded, and display output is controlled using the 3D image format information. In this procedure, resizing, reshaping, and 3D conversion are performed according to type of the display device to output a stereoscopic image.

(3) A case in which the multiplexing format of the received 3D video data does not coincide with the multiplexing format supported by the display device

The multiplexing format of the received 3D video data may be different from the multiplexing format supported by the display device.

In an embodiment, the received 3D video data may have a side-by-side format, and the display type of the display device may support only checker board type output. In this case, the broadcast receiver may sample and decode the 3D video stream received through the output formatter 10060 using the 3D image format information to convert the 3D video stream into a checker board output signal and output the checker board output signal.

In another embodiment, the broadcast receiver may perform resizing and formatting for output of a spatially multiplexed format (side-by-side format, top-bottom format, or interlaced format) or a temporally multiplexed format (frame-sequential format or field-sequential format) through the output formatter 10060 according to display capacity/type. Also, the broadcast receiver may perform frame rate conversion for coincidence with a frame rate supported by the display device.

(4) A case in which signaling information for 3D metadata is received through the SDT

The broadcast receiver may determine whether a 3DTV service is provided through a corresponding virtual channel using the service_type field of the Service Descriptor of the SDT or identify a 3D stereoscopic video service through the presence of the stereo format descriptor.

Upon determining that 3DTV service is provided, the broadcast receiver receives component_tag information of a 3D stereo video using the stereo format descriptor (component_tag_S).

The broadcast receiver finds and parses a PMT having a program_number field coinciding with a value of the service_id field of the SDT.

The broadcast receiver finds one, a value of the component_tag field of the Stream Identifier Descriptor of the ES_descriptor_loop is component_tag_S, from among elementary streams of the PMT to receive elementary PID information of the 3D Stereoscopic video component (PID_S).

The broadcast receiver acquires stereo configuration information regarding a stereo video element and information regarding left/right disposition, left/right priority output, and left/right reverse scanning, through the stereo format descriptor acquired through the SDT.

In a case in which an image is viewed in a 2D mode, the stereo video stream is decoded to decimate only data corresponding to a view designated by the LR_output_flag, interpolation/resizing is performed with respect to the decimated data, and the interpolated/resized data are output to the display device.

In a case in which an image is viewed in a 3D mode, the stereo video stream is decoded, and display output is controlled using the stereo format descriptor information. In this procedure, resizing and 3D format conversion are performed according to display type of the 3DTV to output a 3D stereoscopic image.

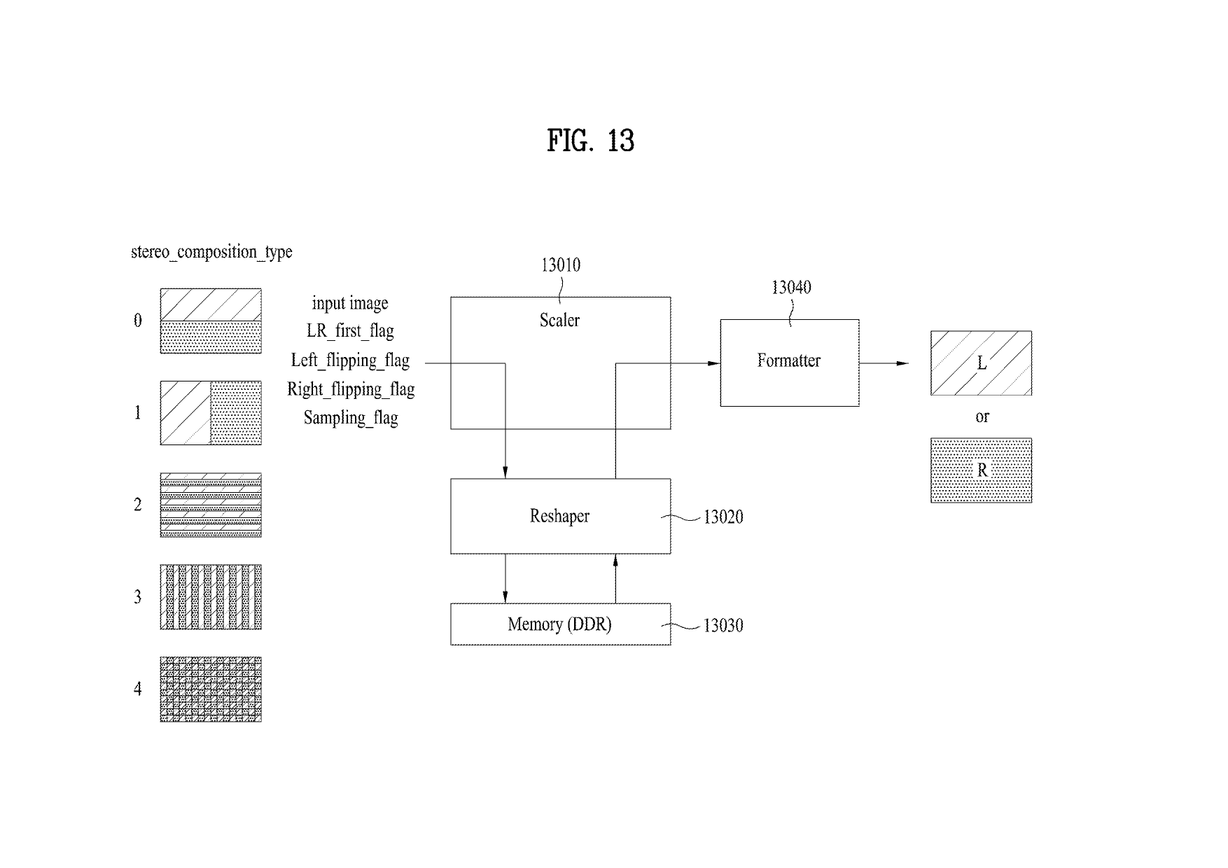

FIG. 13 is a view showing configuration of a broadcast receiver to output received 3D video data as a 2D image using 3D image format information according to an embodiment of the present invention.

Referring to FIG. 13, the broadcast receiver may reconfigure 3D video data, in which a left view image and a right view image constitute one frame, as a frame having only a left view image or a right view image using 3D image information to output a 2D image.

As shown in the left side of FIG. 13, the multiplexing format of the 3D video data is changed based on a field value of the stereo_composition_type field. That is, the broadcast receiver may parse system information and identify that the multiplexing format of the 3D video data is a top-bottom format in a case in which a field value of the stereo_composition_type is ‘0’, that the multiplexing format of the 3D video data is a side-by-side format in a case in which a field value of the stereo_composition_type is ‘1’, that the multiplexing format of the 3D video data is a horizontally interlaced format in a case in which a field value of the stereo_composition_type is ‘2’, that the multiplexing format of the 3D video data is a vertically interlaced format in a case in which a field value of the stereo_composition_type is ‘3’, and that multiplexing format of the 3D video data is a checker board format in a case in which a field value of the stereo_composition_type is ‘4’.

The right side of the drawing conceptually shows an output formatter of the broadcast receiver. In an embodiment, the output formatter of the broadcast receiver may include a scaler 13010, a reshaper 13020, a memory (DDR) 13030, and a formatter 13040.

The scaler 13010 performs resizing and interpolation with respect to a received image. For example, the scaler 13010 may perform resizing (various resizing, such as ½resizing and doubling (2/1 resizing), may be performed according to resolution and image size), quincunx, and reverse sampling according to the format of a received image and the format of an output image.

The reshaper 13020 extracts a left/right view image from the received image and stores the extracted left/right view image or extracts an image read from the memory 13030. Also, in a case in which a map of the image stored in the memory 13030 is different from a map of an image to be output, the reshaper 13020 may also serve to read the image stored in the memory 13030 and map the read image with an image to be output.

The memory 13030 stores or buffers the received image and outputs the stored or buffered image.

The formatter 13040 converts the format of an image according to image format to be displayed. For example, the formatter 13040 may convert an image having a top-bottom format into an interlaced format.

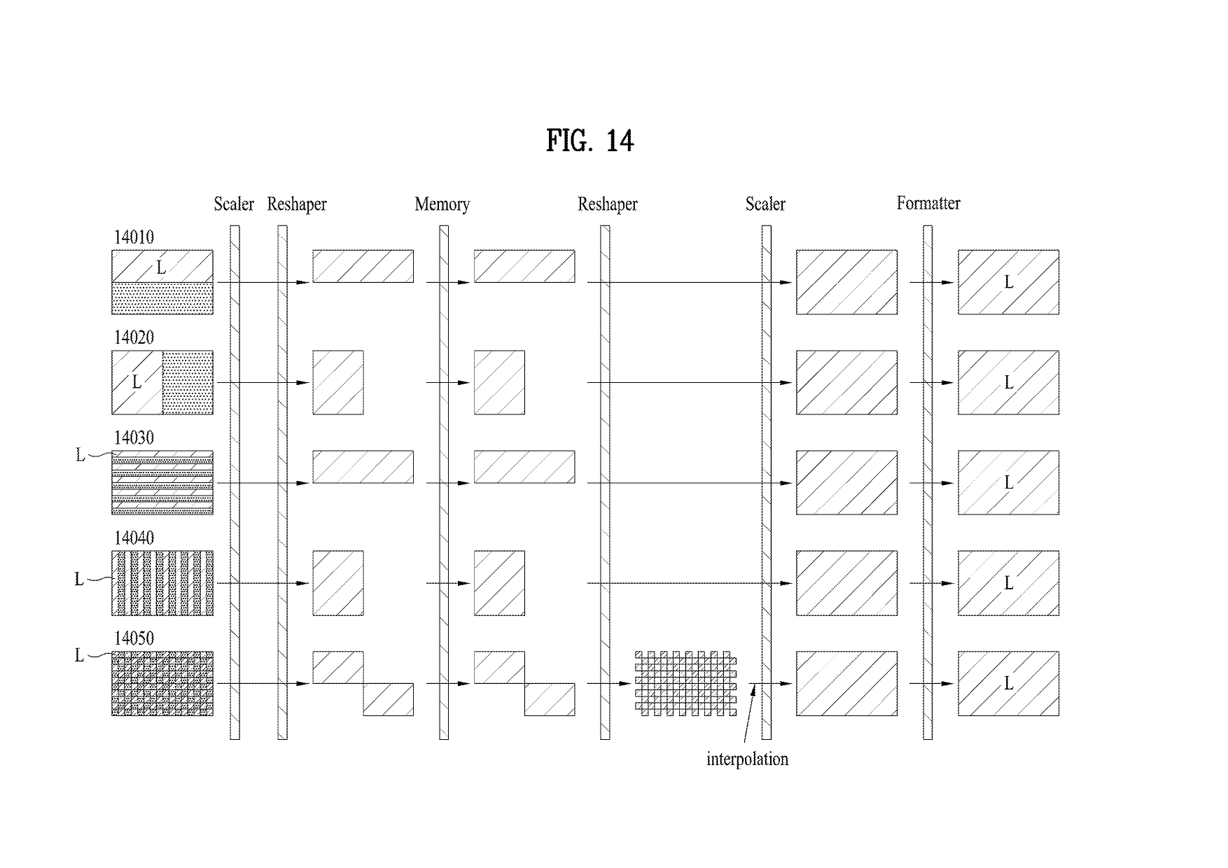

FIGS. 14 to 16 are views showing a method of outputting received 3D video data as a 2D image according to an embodiment of the present invention.

FIG. 14 is a view showing a method of outputting received 3D video data as a 2D image using stereo format information according to an embodiment of the present invention.

FIG. 14 shows the operation of the broadcast receiver in a case in which the respective fields of the stereo format descriptor have the following field values: LR_first_flag=0, LR_output_flag=0, Left_flipping_flag=0, Right_flipping_flag=0, and Sampling_flag=1.

The field value of the LR_first_flag field is ‘0’, i.e. the left upper end image is a left view image, and the field value of the LR_output_flag field is ‘0’. Consequently, it can be seen that the broadcast receiver outputs a left view image during outputting of a 2D image. Also, both the field value of the Left_flipping_flag field and the field value of the Right_flipping_flag field are ‘0’, and therefore, it can be seen that reverse scanning of the image is not necessary. The field value of the sampling_flag field is ‘1’, and therefore, it can be seen that quincunx sampling has not been performed and ½ resizing (for example, decimation) has been performed in the horizontal direction or in the vertical direction.

In a case in which an image 14010 having a top-bottom format is received (stereo_composition_type=0), the reshaper extracts an upper end left view image to be output and stores the extracted image in the memory, and reads and outputs the stored image from the memory. In the top-bottom format image, a map of an image to be output coincides with a map of the image stored in the memory, and therefore, additional mapping may not be required. The scaler performs interpolation or vertical 2/1 resizing with respect to the upper end image to output a full screen left view image. In a case in which a 2D image is output, it is not necessary to convert a multiplexing format of the image, and therefore, the formatter may bypass the image received from the scaler.

In a case in which an image 14020 having a side-by-side format is received (stereo_composition_type=1), the reshaper extracts a left side left view image to be output and stores the extracted image in the memory, and reads and outputs the stored image from the memory. In the side-by-side format image, a map of an image to be output coincides with a map of the image stored in the memory, and therefore, additional mapping may not be required. The scaler performs interpolation or horizontal 2/1 resizing with respect to the left side image to output a full screen left view image.

In a case in which an image 14030 having a horizontally interlaced format is received (stereo_composition_type=2), the reshaper extracts a left view image to be output and stores the extracted image in the memory, and reads and outputs the stored image from the memory. In the horizontally interlaced format image, an image to be output has an interlaced format. In a case in which the image is stored in the memory, however, the image may be stored in a state in which no empty pixels are disposed between interlaced pixels for storage efficiency. In this case, the reshaper may read the image from the memory and output the read image to the scaler. The scaler performs interpolation or 2/1 resizing with respect to the interlaced format image to output a full screen image.

In a case in which an image 14040 having a vertically interlaced format is received (stereo_composition_type=3), the reshaper extracts a left view image to be output and stores the extracted image in the memory, and reads and outputs the stored image from the memory. In the vertically interlaced format image, an image to be output has an interlaced format. In a case in which the image is stored in the memory, however, the image may be stored in a state in which no empty pixels are disposed between interlaced pixels for storage efficiency. In this case, the reshaper may read the image from the memory and output the read image to the scaler. The scaler performs interpolation or 2/1 resizing with respect to the interlaced format image to output a full screen image.

In a case in which an image 14050 having a checker board format is received (stereo_composition_type=3), the reshaper extracts a left view image to be output and stores the extracted image in the memory, and reads and outputs the stored image from the memory. In the checker board format image, an image to be output has a checker board format. In a case in which the image is stored in the memory, however, the image may be stored without empty pixels for storage efficiency. In this case, the reshaper may read the image from the memory, map the read image into a checker board format image, and output the mapped image to the scaler. The scaler performs interpolation or 2/1 resizing with respect to the checker board format image to output a full screen image.

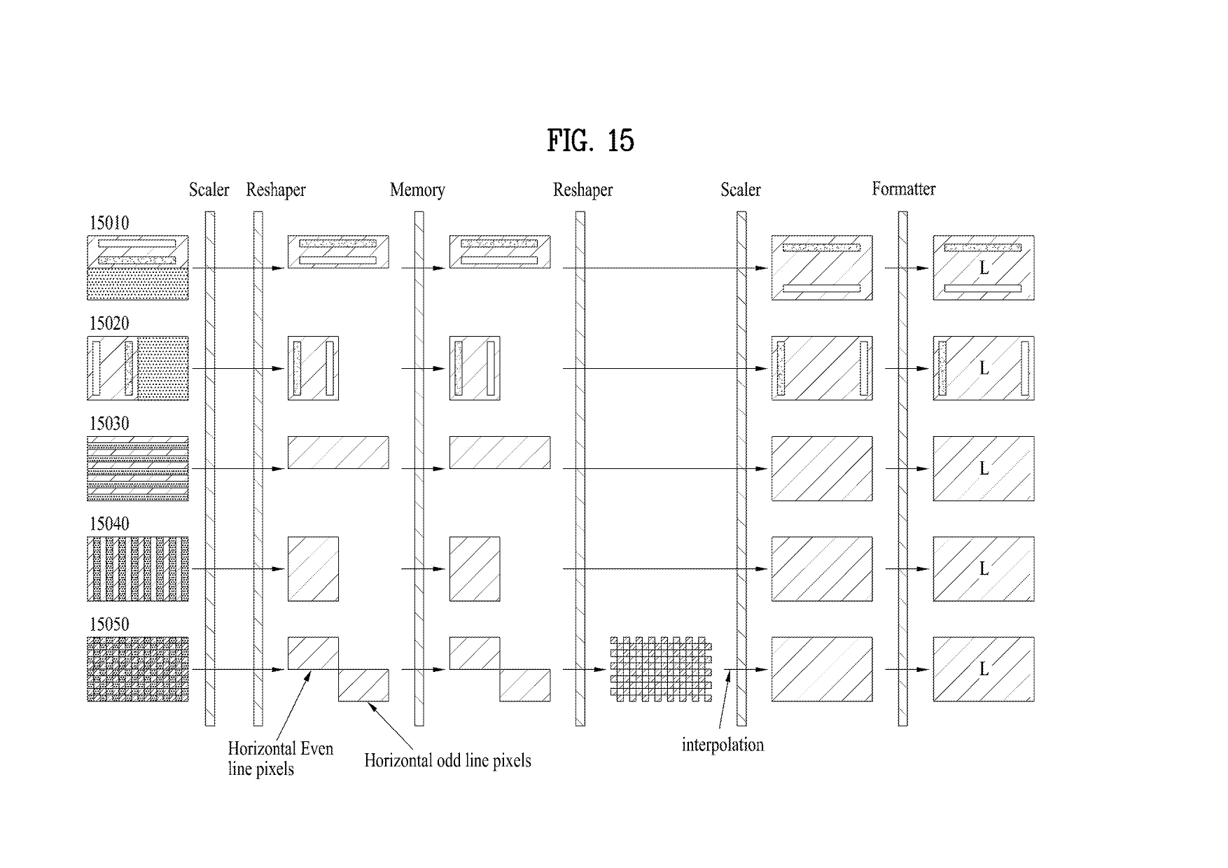

FIG. 15 is a view showing a method of outputting received 3D video data as a 2D image using 3D image format information according to another embodiment of the present invention.

FIG. 15 shows the operation of the broadcast receiver in a case in which the respective fields of the stereo format descriptor have the following field values: LR_first_flag=0, LR_output_flag=0, Left_flipping_flag=1, Right_flipping_flag=0, Sampling_flag=1. The field value of the LR_first_flag field is ‘0’, i.e. the left upper end image is a left view image, and the field value of the LR_output_flag field is ‘0’. Consequently, it can be seen that the broadcast receiver outputs a left view image during outputting of a 2D image. Also, the field value of the Left_flipping_flag field is ‘1’, and therefore, it can be seen that reverse scanning of the left view image is necessary. The field value of the Right_flipping_flag is ‘0’. Also, the left view image is output when the 2D image is output, and therefore, the right view image may be scanned in the forward direction or may not be scanned according to the broadcast receiver. The field value of the sampling_flag field is ‘1’, and therefore, it can be seen that quincunx sampling has not been performed and ½ resizing (for example, decimation) has been performed in the horizontal direction or in the vertical direction.

In a case in which an image 15010 having a top-bottom format is received (stereo_composition_type=0), the reshaper extracts an upper end left view image to be output and stores the extracted image in the memory, and reads and outputs the stored image from the memory. At this time, since the field value of the Left_flipping_flag field is ‘1’, the left view image is scanned in the reverse direction when the left view image is read and stored. The scaler performs vertical 2/1 resizing with respect to the upper end image to output a full screen left view image. In a case in which a 2D image is output, it is not necessary to convert a multiplexing format of the image, and therefore, the formatter may bypass the image received from the scaler.

In a case in which an image 15020 having a side-by-side format is received (stereo_composition_type=1), the reshaper extracts a left side left view image to be output and stores the extracted image in the memory, and reads and outputs the stored image from the memory. At this time, since the field value of the Left_flipping_flag field is ‘1’, the left view image is scanned in the reverse direction when the left view image is read and stored. The scaler performs horizontal 2/1 resizing with respect to the left side image to output a full screen left view image.

In FIG. 14, the horizontally interlaced format image 14030, the vertically interlaced format image 14040, and the checker board format image 14050, the broadcast receiver ignores the Left_flipping_flag field and the Right_flipping_flag field according to embodiments for system realization, and therefore, video data processing is performed using the same method as in the horizontally interlaced format image 13030, the vertically interlaced format image 13040, and the checker board format image 13050 shown in FIG. 13. Consequently, a description thereof will be omitted. According to embodiments for system realization, however, it may be determined whether the image is to be scanned in the reverse direction using the Left_flipping_flag field and the Right_flipping_flag field in addition to the multiplexing format as previously described.

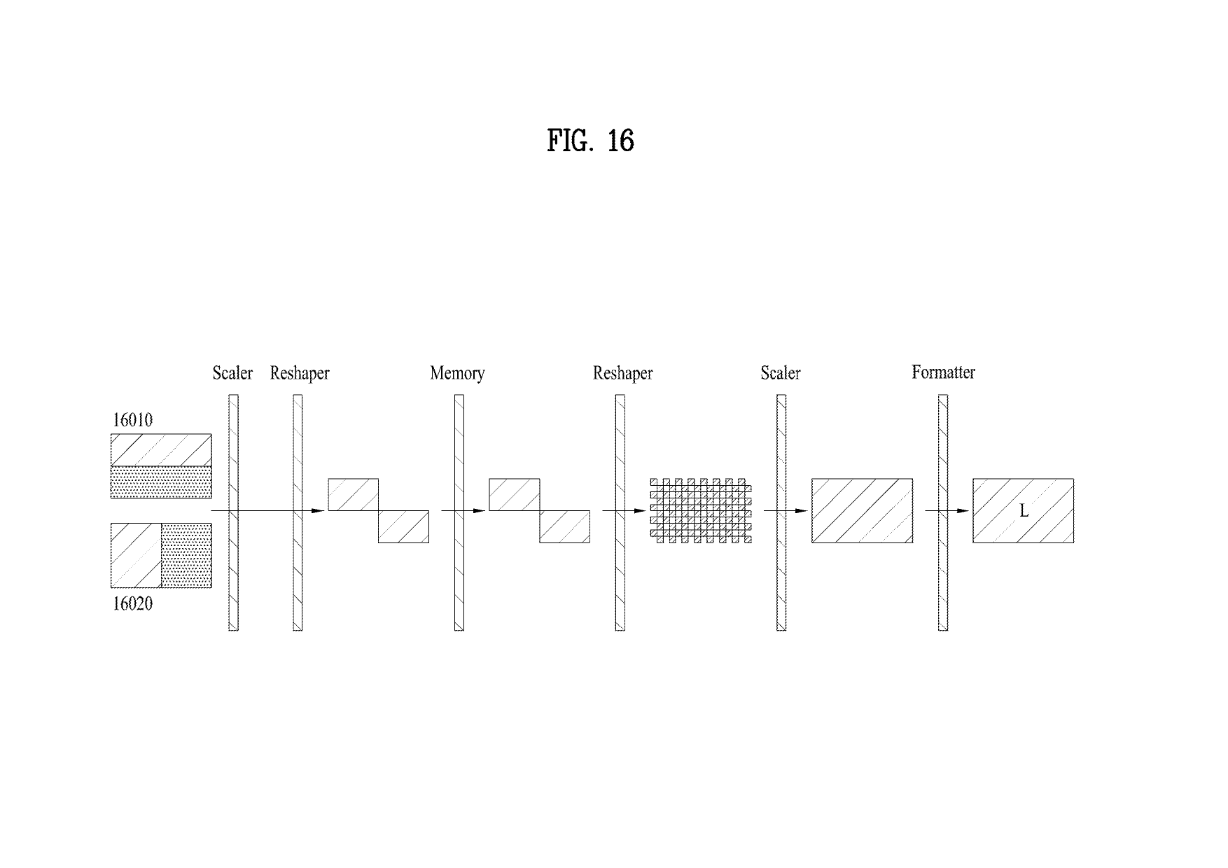

FIG. 16 is a view showing a method of outputting received 3D video data as a 2D image using 3D image format information according to a further embodiment of the present invention.

FIG. 16 shows the operation of the broadcast receiver in a case in which the respective fields of the stereo format descriptor have the following field values: LR_first_flag=0, LR_output_flag=0, Left_flipping_flag=0, Right_flipping_flag=0, Sampling_flag=1. The field value of the LR_first_flag field is ‘0’, i.e. the left upper end image is a left view image, and the field value of the LR_output_flag field is ‘0’. Consequently, it can be seen that the broadcast receiver outputs a left view image during outputting of a 2D image. Also, the field value of the Left_flipping_flag field is ‘0’, and therefore, it can be seen that reverse scanning of the left view image is not necessary. The field value of the sampling_flag field is ‘0’, and therefore, it can be seen that quincunx sampling has been performed.

The receiver may receive a top-bottom format image 16010 and a side-by-side format image 16020, and the reshaper may read and store a left view image. In a case in which the reshaper reads the image stored in the memory, a vertically ½ resized image or a horizontally ½ resized image is not read but a checker board format image is read. In a case in which the reshaper reads the left view image from the memory, therefore, the reshaper maps and output a quincunx sampled checker board format image. The scaler may receive the checker board format image and perform quincunx reverse sampling with respect to the received image to output a full screen left view image.

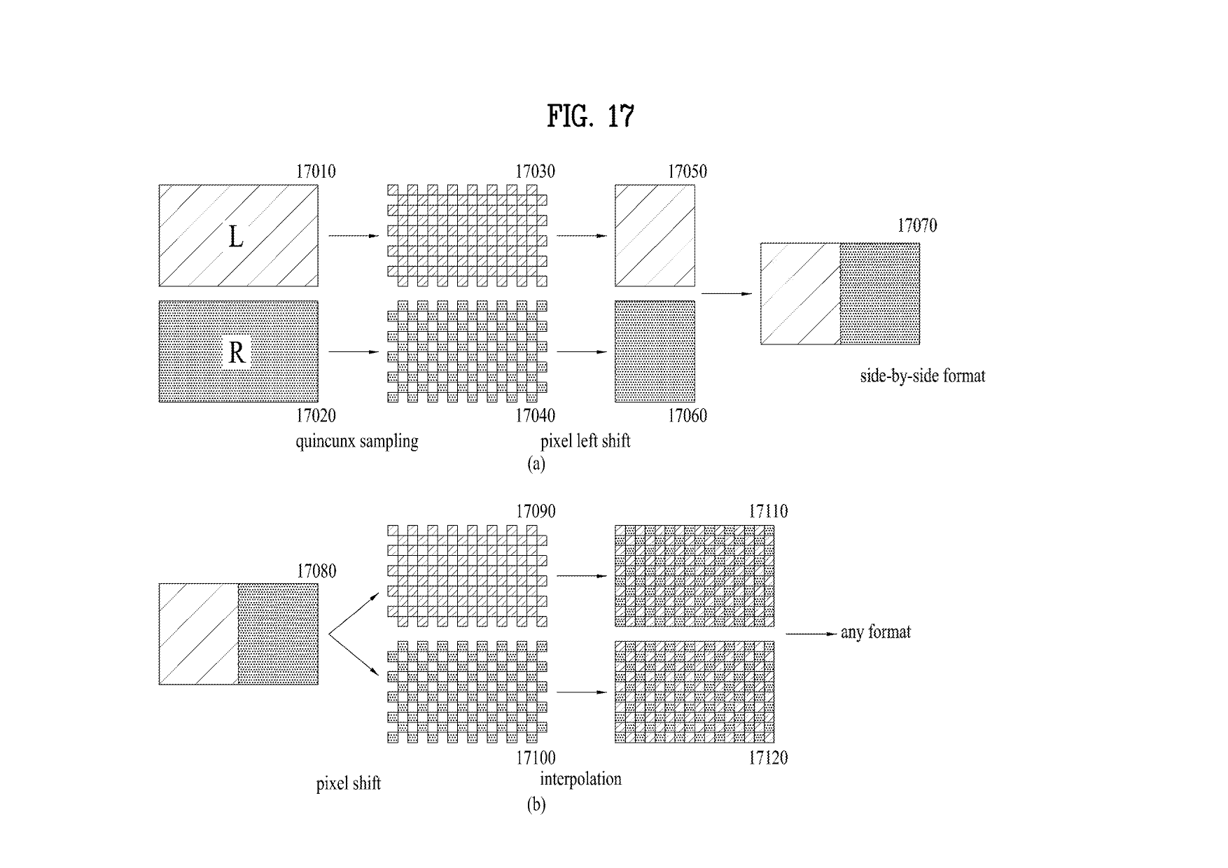

FIG. 17 is a view showing a 3D video data processing method using quincunx sampling according to an embodiment of the present invention.

FIG. 17(a) shows image processing at an encoder side of a transmitter, and FIG. 17(b) shows image processing at a decoder side of a receiver.

Referring to FIG. 17(a), in order to transmit a side-by-side format image, the broadcast transmitter performs quincunx sampling with respect to a left view image 17010 and a right view image 17020 of a full screen to acquire a sampled left view image 17030 and a sampled right view image 17040. The broadcast transmitter pixel shifts the sampled left view image 17030 and the sampled right view image 17040 to acquire a left view image 17050 resized into ½ screen and a right view image 17060 resized into ½ screen. The resized images 17050 and 17060 are configured into one screen to acquire a side-by-side format image 17070 to be transmitted. In the embodiment of FIG. 17, the side-by-side format is described as an example, and the quincunx sampled images are pixel shifted in the horizontal direction to acquire side-by-side format image. In a case in which a top-bottom format image is acquired, however, the quincunx sampled images may be pixel shifted in the vertical direction to configure an image.

Referring to FIG. 17(b), the broadcast receiver receives a top-bottom format image 17080. Since a field value of a sampling_flag field of 3D image format information is ‘0’, it can be seen that quincunx sampling has been performed in the transmitter. When scanning and pixel shifting the received top-bottom format image 17080, therefore, the broadcast receiver may output images 17090 and 17100 having the same forms as quincunx sampled images and perform quincunx reverse sampling during interpolation to acquire a left view image 17110 and a right view image 17020 of a full screen.

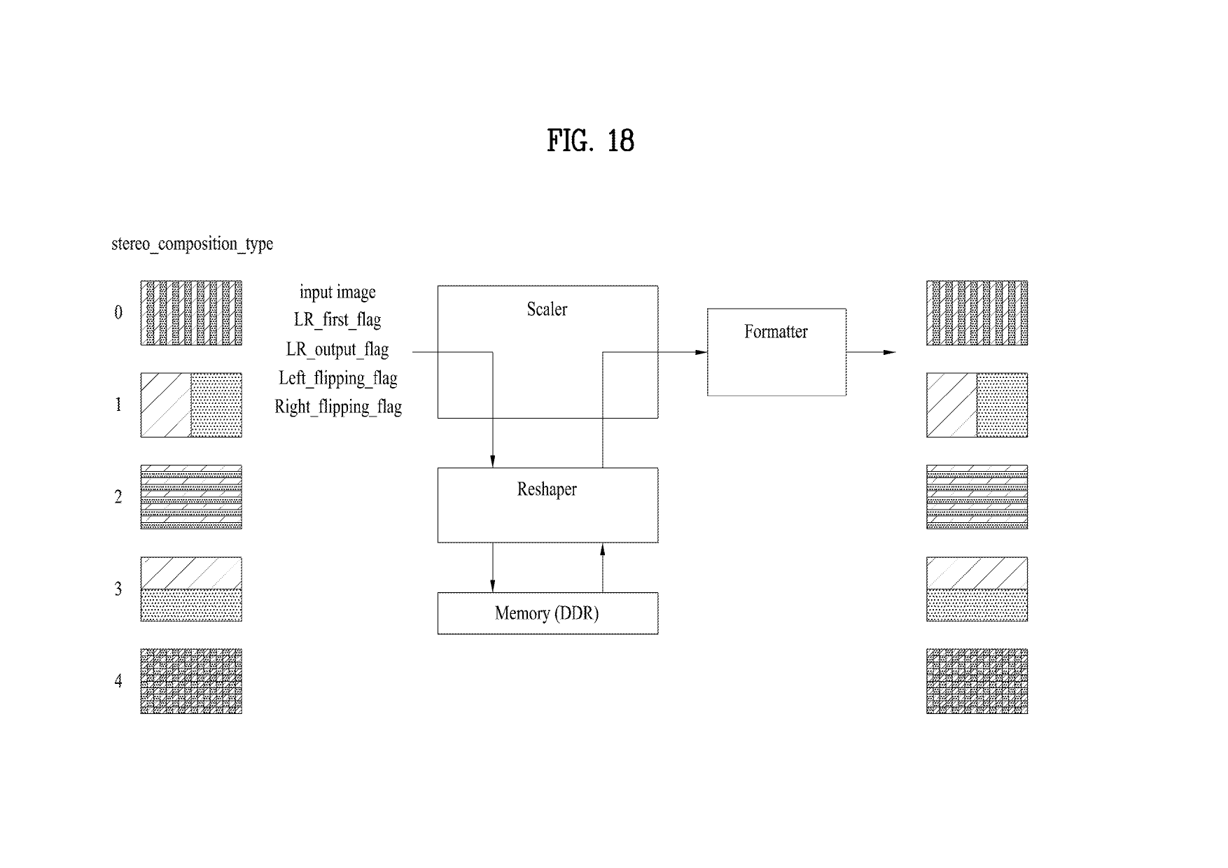

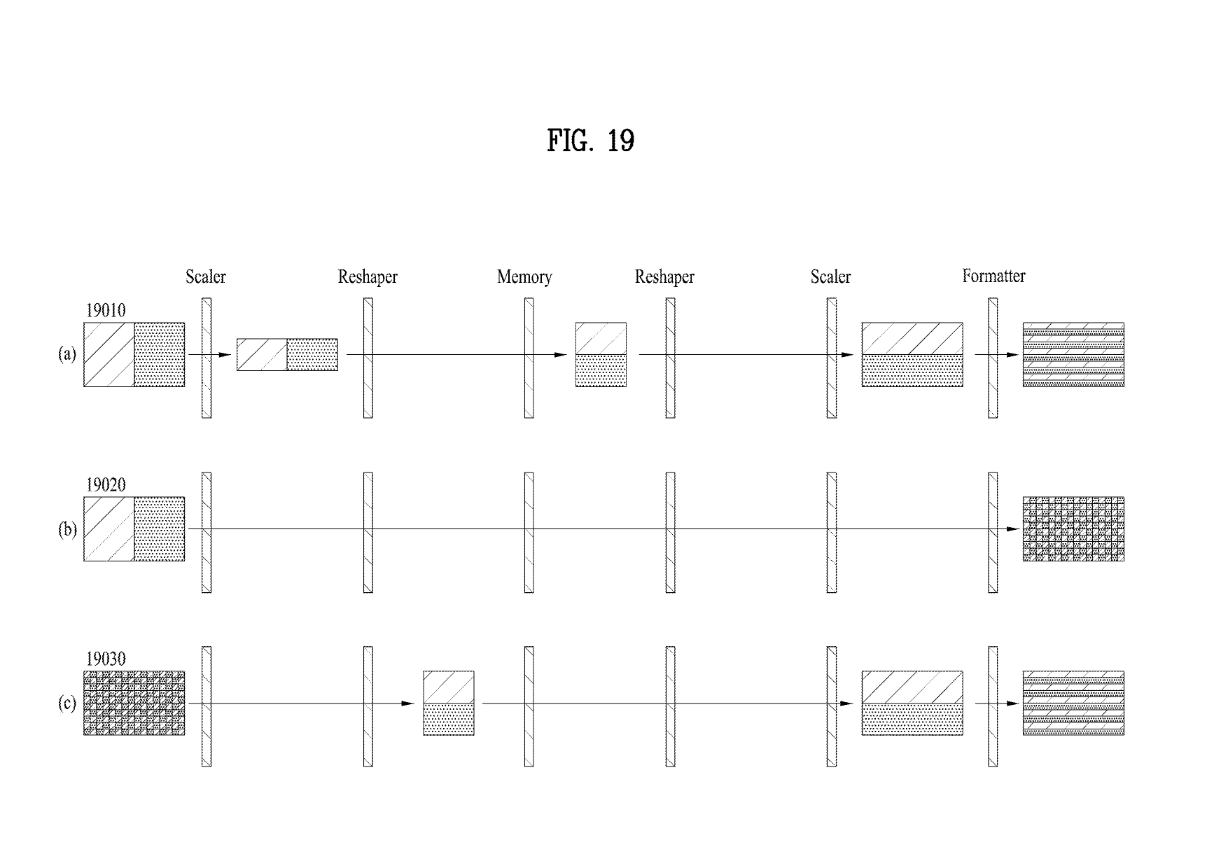

Embodiments of FIGS. 18 and 19 show a method of format converting an image into a multiplexing format different from the received multiplexing format and outputting the converted image using stereo format information in a broadcast receiver

FIG. 18 is a view showing an example of configuration of a broadcast receiver to convert a multiplexing format of a received image and output the converted image using 3D image format information according to an embodiment of the present invention.

A description of features of FIG. 18 identical to those of FIG. 13 will be omitted. In the embodiment of FIG. 13, a 2D image (a frame including one viewpoint images) is output, and the formatter outputs the received image without change. In the embodiment of FIG. 18, on the other hand, the formatter processes received 3D video data to convert the 3D video data into an output format designated by a display device or a broadcast receiver.

FIGS. 19(a) to 19(c) are views showing a video data processing method of a broadcast receiver to convert a multiplexing format of a received image and output the converted image using 3D image format information according to an embodiment of the present invention.

First, an embodiment in which a multiplexing format of a received 3D image is a side-by-side format and an output format is a horizontally interlaced format will be described. Respective fields of the 3D image format information have the following field values: LR_first_flag=0, LR_output_flag=0, stereo_composition_type=1, Left_flipping_flag=0, Right_flipping_flag=0, and Sampling_flag=0.

The scaler performs vertical ½ resizing with respect to a received side-by-side format image 19010 and outputs the resized image. The reshaper stores the output image in the memory and scans and outputs the store image in a top-bottom format. The scaler performs horizontal 2/1 resizing with respect to the top-bottom format image. The formatter converts and outputs the received top-bottom format image of a full screen in a horizontally interlaced format.

Next, an embodiment in which a multiplexing format of a received 3D image is a side-by-side format and an output format is a checker board format will be described. Respective fields of the 3D image format information have the following field values: LR_first_flag=0, LR_output_flag=0, stereo_composition_type=1, Left_flipping_flag=0, Right_flipping_flag=0, and Sampling_flag=0.

In the checker board format, only format conversion is performed with respect to a ½ resized image 19020, such as a side-by-side format image or a top-bottom format image, when the ½ resized image 19020 is received. That is, the formatter converts and outputs only the multiplexing format of the received side-by-side format image without additional image processing performed by the scaler and the reshaper. According to embodiments, on the other hand, a left view image and a right view image may be read from the received side-by-side format image to ½ resize the received side-by-side format image, the left view image and the right view image of a full screen may be ½ downsampled in the checker board format, and the two image may be mixed.

Finally, an embodiment in which a multiplexing format of a received 3D image is a checker board format and an output format is a horizontally interlaced format will be described. Respective fields of the 3D image format information have the following field values: LR_first_flag=0, LR_output_flag=0, stereo_composition_type=4, Left_flipping_flag=0, Right_flipping_flag=0, and Sampling_flag=0.

In a case in which a checker board format image 19030 is received, the reshaper scans the image, reshapes the scanned image into a horizontally ½ sized top-bottom format image, stores the reshaped image, and output the stored image. The scaler performs horizontally ½ resizing with respect to the received ½ sized top-bottom format image to output a top-bottom format image of a full screen. The formatter format converts the top-bottom format image of the full screen to output a horizontally interlaced format image.

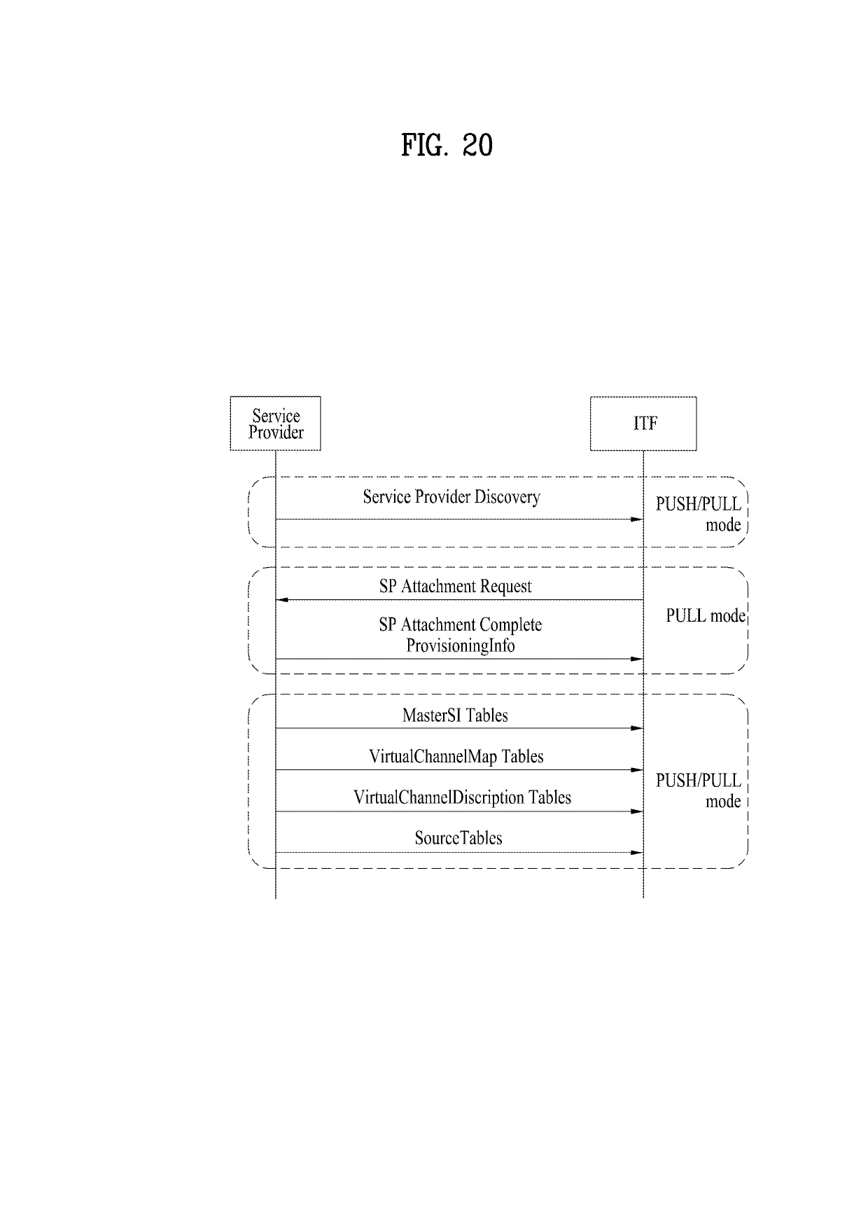

FIG. 20 is a view illustrating an IPTV service search process in connection with the present invention.

FIG. 20 is a view showing a 3D service acquisition process in an IPTV according to an embodiment of the present invention.

An IPTV Terminal Function (ITF) is a push/pull mode, in which information for Service Provider Discovery is received from service providers. The Service Provider Discovery is a process of service providers who provide an IPTV finding a server providing information regarding services of the service providers. For example, the Service Provider Discovery provides a service provision server for each service provider as follows. That is, the receiver finds an address list, from which information regarding Service Discovery (SD) Servers (SP discovery information) is received, as follows.

In an embodiment, the receiver receives Service Provider (SP) Discovery information from an automatically or manually preset address. At this time, the receiver may receive corresponding information from an address preset in the ITF, or a user may manually set a specific address such that the receiver receives SP Discovery information desired by the user.

In another embodiment, the receiver may perform SP Discovery based on a DHCP. That is, the receiver may obtain SP Discovery information using a DHCP option.

In a further embodiment, the receiver may perform SP Discovery based on a DNS SRV. That is, the receiver may obtain SP Discovery information through a query using a DNS SRV mechanism.

The receiver accesses a server having an address acquired using the above method to receive information including Service Provider Discovery Record containing information necessary for Service Discovery of a Service Provider (SP). The receiver performs a service search process through the information including the Service Provider Discovery Record. Data related to the Service Provider Discovery Record may be provided in a push mode or in a pull mode.

The receiver accesses an SP Attachment Server of a Service Provider access address (for example, an address designated as SPAttachmentLocator) based on the information of the Service Provider Discovery Record to perform an ITF registration procedure (Service Attachment procedure). At this time, information transmitted from the ITF to the server may be transmitted in the form of, for example, an ITFRegistrationlnputType record, and the ITF may provide this information in the form a query Term of an HTTP GET method to perform Service Attachment.

In an embodiment, the receiver may selectively access an Authentication service server of an SP designated as SPAuthenticationLocator to perform an additional authentication procedure and then perform Service Attachment. In this case, the receiver may transmit ITF information in a form similar to that in the case of the Service Attachment to the server to perform authentication.

The receiver may receive data in the form of ProvisioningInfoTable from the service provider. This procedure may be omitted.

The receiver contains ID and position information of the receiver in data to be transmitted to the server during a Service Attachment procedure of an ITFRegistrationlnputType record.

The Service Attachment server may specify a service subscribed to by the receiver based on the information provided by the receiver. The Service Attachment server may provide an Service Information acquirable address, which is to be received by the receiver, in the form of ProvisioningInfoTable based thereupon. For example, this address may be used as access information of a MasterSiTable. This method has an effect of configuring and providing a customized service for each subscriber.

The receiver may receive a VirtualChannelMap Table, a VirtualChannelDescription Table, and/or a SourceTable based on the information received from the service provider.

The VirtualChannelMap Table provides a MasterSiTable administrating access information and version regarding VirtualChannelMap and a service list in the form of a package.

The VirtualChannelDescription Table contains detailed information of each channel.

The SourceTable contains access information, based on which a real service is accessed.

The VirtualChannelMap Table, the VirtualChannelDescription Table and the SourceTable may be classified as service information. Such service information may further include information of the above descriptors. In this case, however, the form of the information may be changed so as to be suitable for a service information scheme of the IPTV.

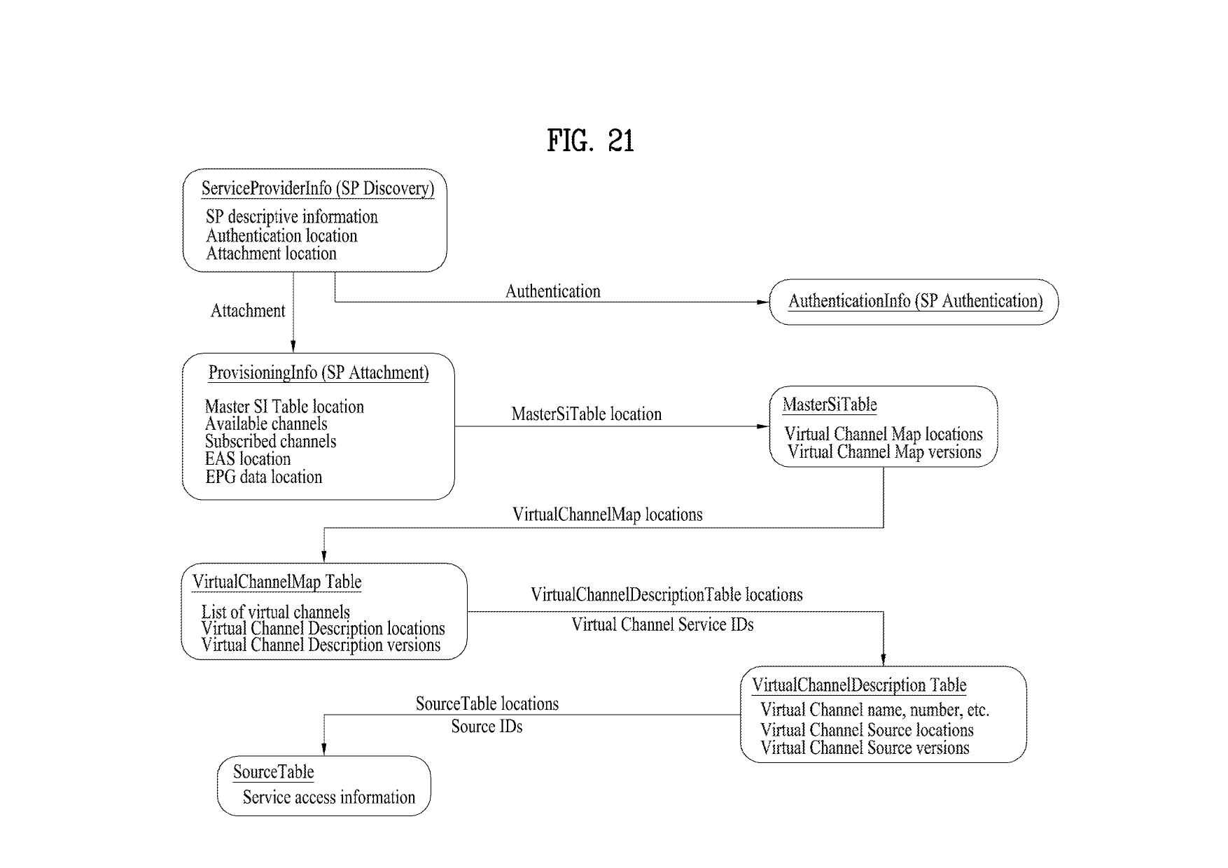

FIG. 21 is a view illustrating an IPTV service SI table and a relationship among components thereof according to the present invention.

FIG. 21 is a view showing the structure of Service Information (SI) table for an IPTV according to an embodiment of the present invention.

FIG. 21 shows Service Provider discovery, attachment metadata components, and Services Discovery metadata components and a relationship thereamong. The receiver may process received data according to procedures indicated by arrows shown in FIG. 21.

ServiceProviderinfo includes SP descriptive information, which is information related to a service provider, Authentication location, which is information regarding a location providing information related to authentication, and Attachment location, which is information related to an attachment location.

The receiver may perform authentication related to a service provider using the Authentication location information.

The receiver may access a server capable of receiving ProvisioningInfo using information included in the Attachment location. ProvisioningInfo may include a MasterSiTable location including a server address capable of receiving a MasterSiTable, an Available channel including information regarding channels that can be provided to a viewer, a Subscribed channel including information regarding subscribed channels, a Emergency Alert System (EAS) location including information related to emergency alert, and/or a Electronic Program Guide (EPG) data location including position information related to an EPG. In particular, the receiver may access an address capable of receiving the Master SI Table using the Master SI Table location information.

A MasterSiTable Record contains position information capable of receiving VirtualChannelMaps and version information of the VirtualChannelMaps.

A VirtualChannelMap is identified by a VirtualChannelMapldentifier, and a VituralChannelMapVersion has version information of the VirtualChannelMap.

In a case in which one of the tables connected in arrow directions starting from a MasterSiTable is changed, such change results in the increase in version number of a corresponding table and the increase in version number of all high-ranking tables (up to the MasterSiTable). Consequently, it is possible to immediately check the change in all SI tables by monitoring the MasterSiTable. For example, in a case in which change occurs in a SourceTable, this change results in the increase the version of the SourceTable, i.e. a SourceVersion. Also, this change results in change of a VirtualChannelDescriptionTable including reference for the SourceTable. In this way, change of the lower-ranking tables results in change of the upper-ranking tables, and finally, change of the MasterSiTable.

Only one MasterSiTable may be present for a service provider. However, in a case in which service configuration is different for each region or for each subscriber (or each subscriber group), it may be efficient to configure an additional MasterSiTable Record in order to provide a customized service for each unit. In this case, it may be possible to provide a customized service suitable for region and subscription information of a subscriber through the MasterSiTable by performing a Service Attachment step.

The MasterSiTable Record provides a list of VitrualChannelMaps.

The VitrualChannelMaps may be identified by VirtualChannelMapldentifiers. Each VitrualChannelMap may have one or more VirtualChannels and designates a position capable of obtaining detailed information regarding VirtualChannels.

A VirtualChannelDescriptionLocation serves to designate a location of a VirtualChannelDescriptionTable containing detailed information of channels.

The VirtualChannelDescriptionTable contains detailed information of VirtualChannels and may access a location capable of providing corresponding information to the VirtualChannelDescriptionLocation of the VirtualChannelMap.

A VirtualChannelServiceID is included in the VirtualChannelDescriptionTable and serves to identify a service corresponding to a VirtualChannelDescription. The receiver may find the VirtualChannelDescriptionTable through a VirtualChannelServiceID. In a case in which the receiver receives a plurality of VirtualChannelDescriptionTables in a multicast mode, the receiver finds the VirtualChannelDescriptionTable identified by a specific VirtualChannelServiceID while joining to a corresponding stream to continuously receive tables.

In case of a unicast mode, the receiver may transmit the VirtualChannelServiceID to the server as a parameter to receive only a desired VirtualChannelDescriptionTable.

A SourceTable provides access information (for example, IP address, port, AV codec, transfer protocol, etc.) necessary to access a real service and/or source information for each service. Since one source may be utilized for several VirtualChannel services, it may be efficient to individually provide source information for each service.

The MasterSiTable, the VirtualChannelMapTable, the VirtualChannelDescriptionTable, and the SourceTable are logically transmitted through four separate flows. A push mode or a pull mode may be unlimitedly used.

However, the MasterSiTable may be transmitted in a multicast mode for version administration, and the receiver may continuously receive a stream transmitting the MasterSiTable to monitor version change.

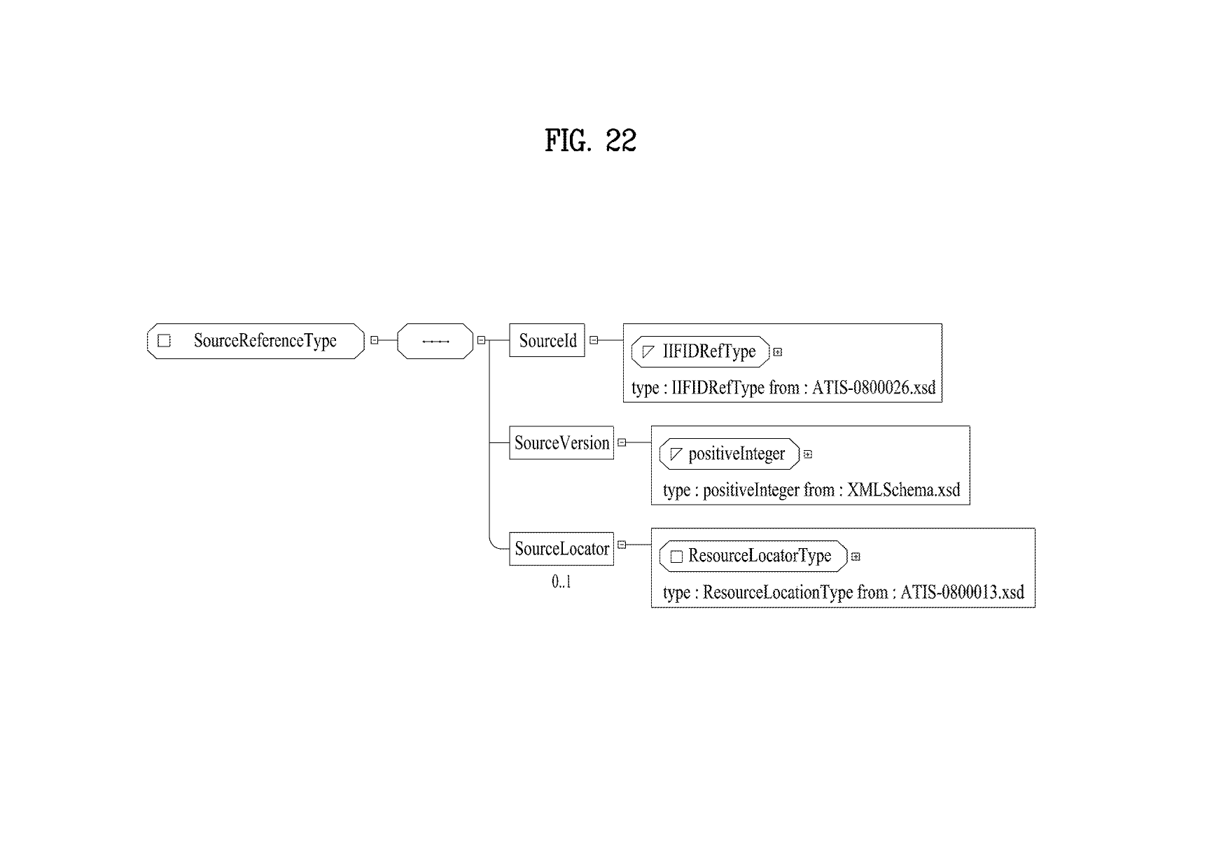

FIG. 22 is a view illustrating an example of a SourceReferenceType XML schema structure according to the present invention.

FIG. 22 is a view showing an XML schema of a SourceReferenceType according to an embodiment of the present invention.

The XML schema of the SourceReferenceType according to the embodiment of the present invention is a structure to reference a source element containing media source information of a Virtual Channel Service.

The SourceReferenceType includes SourceId, SourceVersion, and/or SourceLocator information.

The SourceId is an identifier of the referenced Source element.

The SourceVersion is a version of the referenced Source element.

The SourceLocator provides a location capable of receiving a SourceTable including the Source element. In an embodiment, in a case in which a DefaultSourceLocator and this element are simultaneously present, this element overrides a default value.

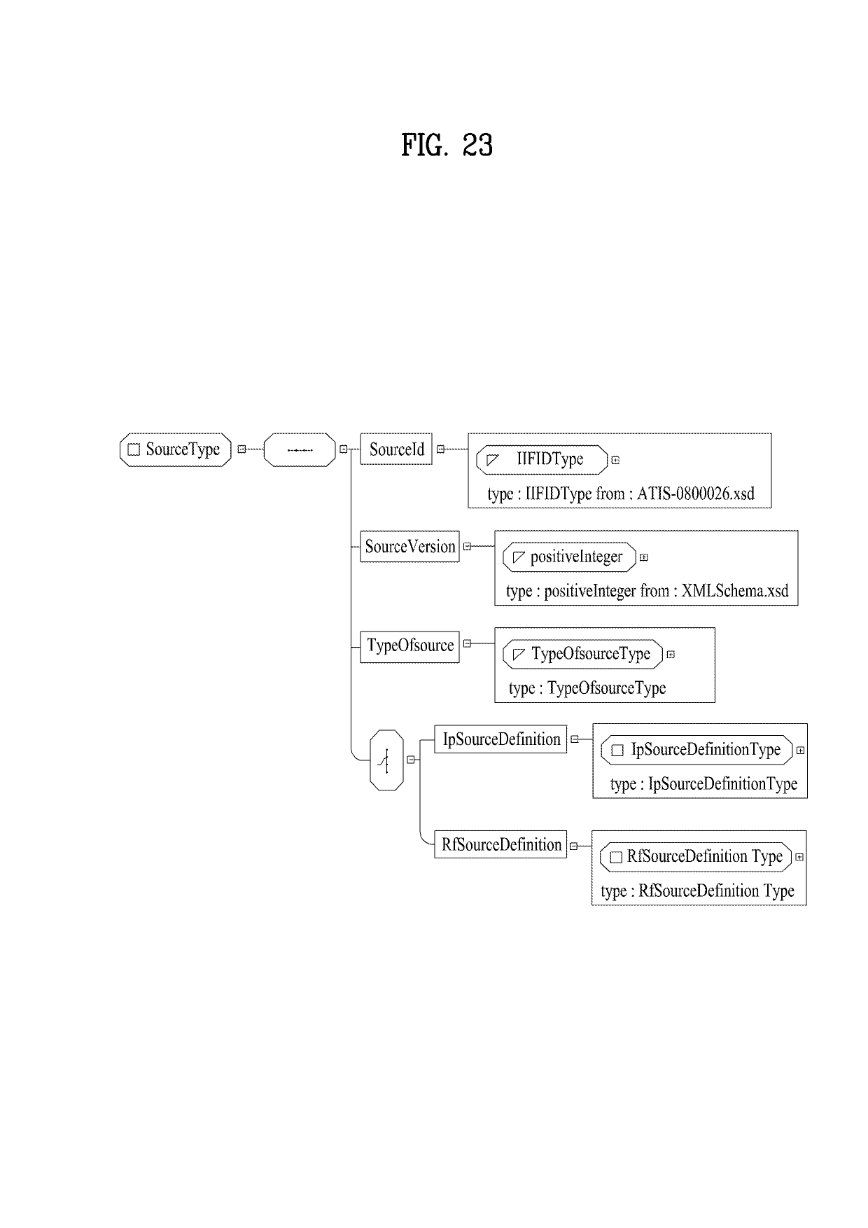

FIG. 23 is a view illustrating an example of a SourceType XML schema structure according to the present invention.

FIG. 23 is a view showing an XML schema of a SourceType according to an embodiment of the present invention.

In an embodiment, the XML schema of the SourceType according to the present invention contains information necessary to acquire a media source of a VirtualChannelService.

The SourceType includes SourceId, SourceVersion, TypeOfSource, IpSourceDefinition, and/or RfSourceDefinition information.

The SourceId is an identifier of the referenced Source element. In an embodiment, it is necessary for this identifier to uniquely indentify this Source element.

The SourceVersion is a version of the referenced Source element. In an embodiment, it is necessary for a value to be increased whenever content of the Source element is changed.

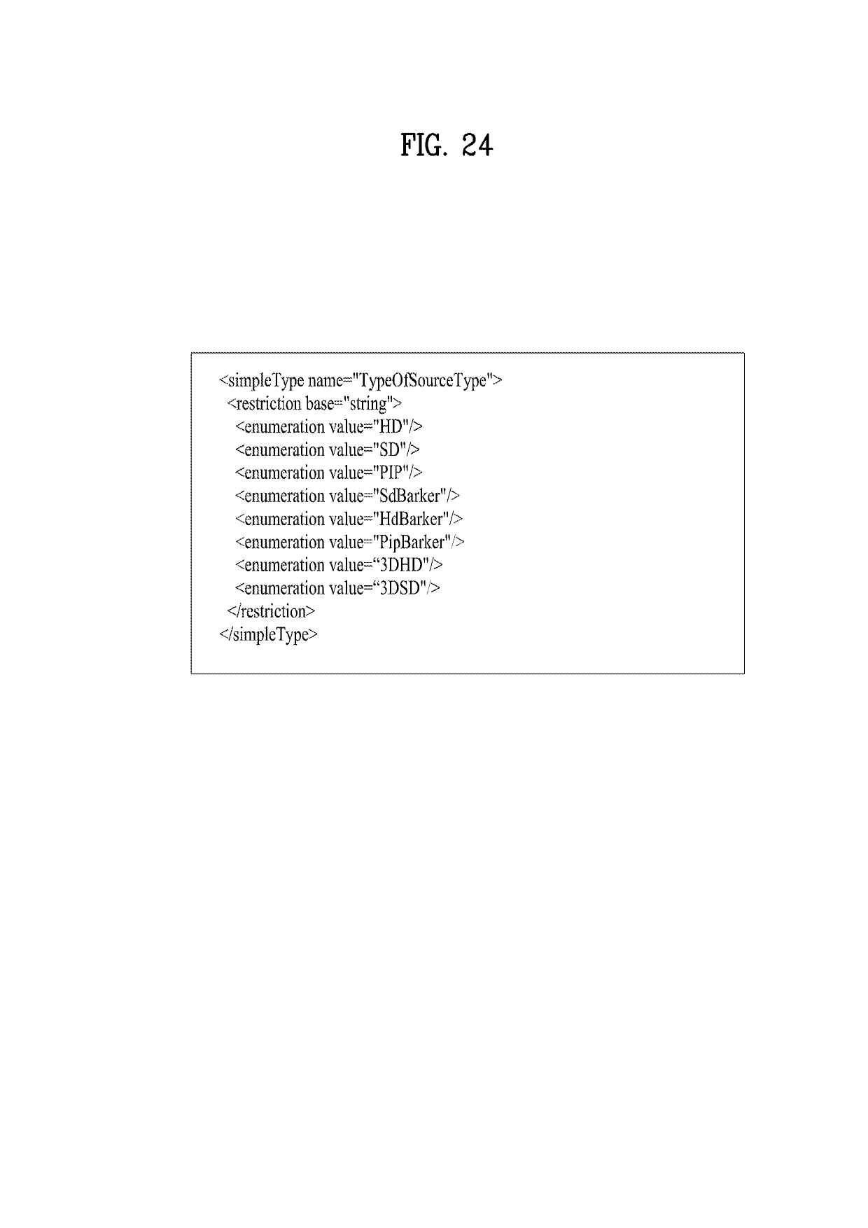

The TypeOfSource is a value indicating characteristics of a corresponding Source. A concrete embodiment of this value will be described with reference to FIG. 24.

In an embodiment, a Barker channel is a channel for advertisement or public information. When viewing a corresponding channel is not authorized with the result that viewing of the corresponding channel is not possible, automatic selection to this channel is performed such that this channel serves to publicize the corresponding channel and introduce subscription of the corresponding channel.

The IpSourceDefinition provides access information of a media source transmitted through an IP network. In an embodiment, the IpSourceDefinition may inform a Multicast IP address, a transfer protocol, and/or various parameters.

The RfSourceDefinition may provide access information of a media source transmitted through a cable TV network.

FIG. 24 is a view illustrating an example of a TypeOfSourceType XML schema structure according to the present invention.

FIG. 24 is a view showing a TypeOfSourceType XML Schema extended to signal information regarding a video image for a 3D service according to an embodiment of the present invention.

In FIG. 24, a TypeOfSource value indicating characteristics of a corresponding Source is defined. HD, SD, PIP, SdBarker, HdBarker, PipBarker, 3D HD, and 3D SD may be indicated based on the value.

In the above, a Barker channel is a channel for advertisement or public information. When viewing a corresponding channel is not authorized with the result that viewing of the corresponding channel is not possible, automatic selection to this channel is performed such that this channel serves to publicize the corresponding channel and introduce subscription of the corresponding channel.

An IPSourceDefinition and an RFSourceDefinition may be extended to provide stereo format information of a 3D source. Provision of such information may be similar to provision of stereo format information for each service in an ATSC or DVB system. Also, in an IPTV system, a service may include various media sources, and therefore, a plurality of source may be designated through a flexible structure as previously described. Consequently, it is possible to provide information for each service by extending such source level information and providing stereo format information.

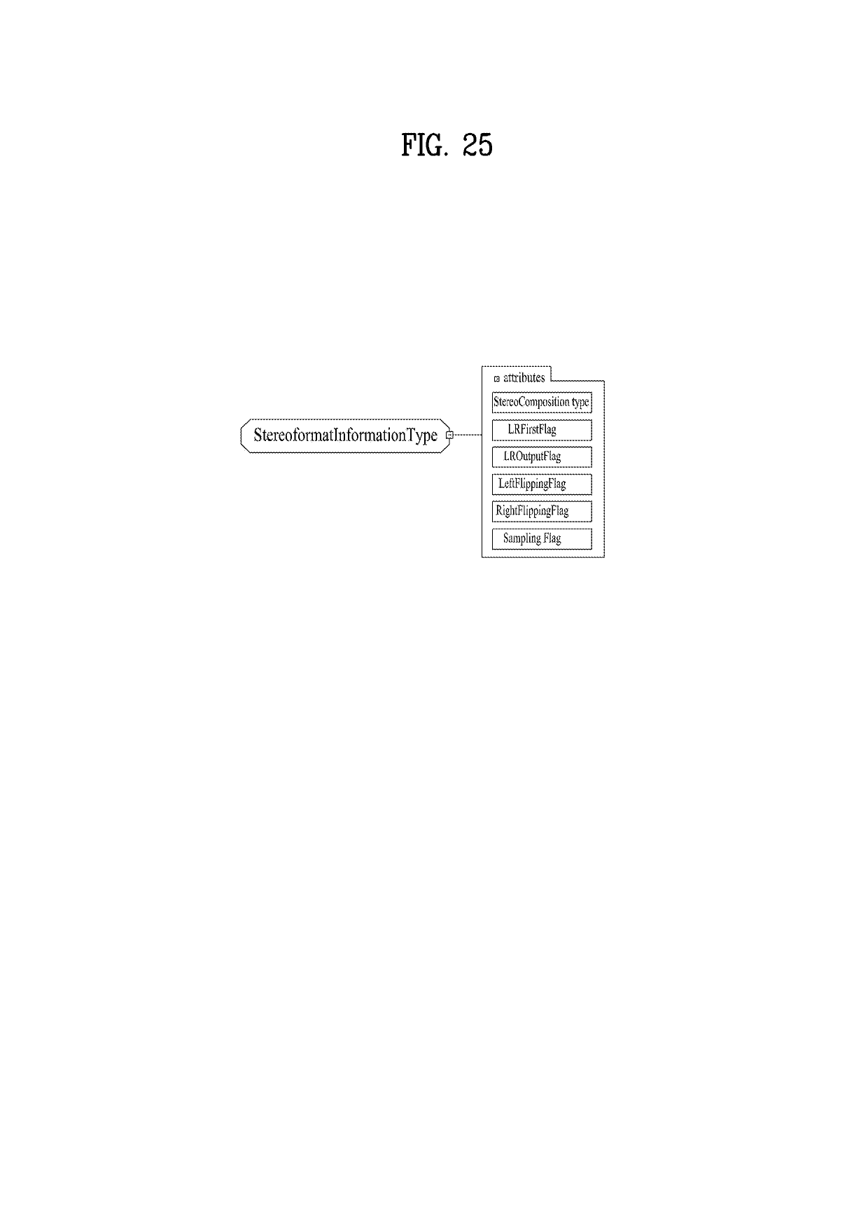

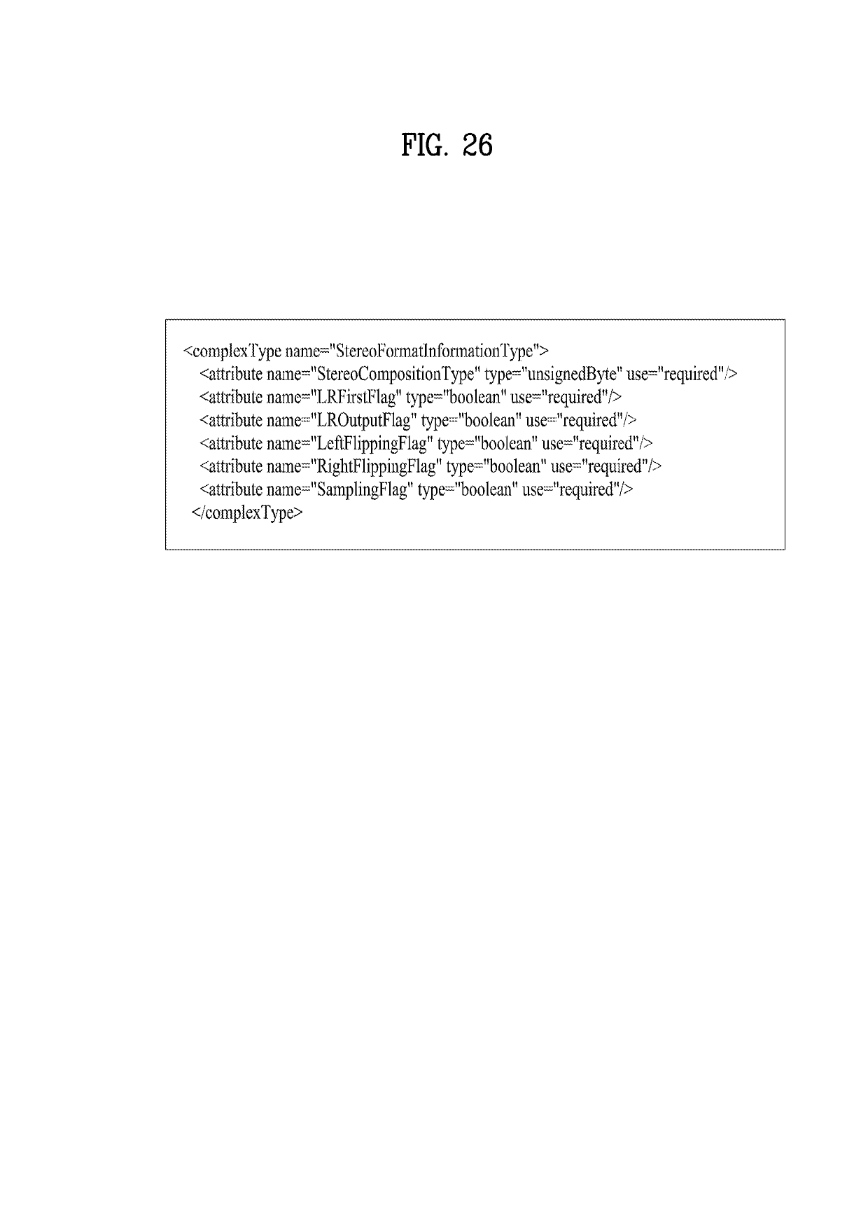

FIG. 25 is a view illustrating an example of a StereoformatInformationType XML schema structure according to the present invention, and FIG. 26 is a view illustrating another example of a StereoformatInformationType XML schema structure according to the present invention.

FIGS. 25 and 26 illustrate elements and types of stereo format information for 3D display according to the present invention.

The StereoformatInformation Type is a type which is newly defined to include stereo format information. As previously described, the StereoformatInformation Type may include information regarding an L/R signal arrangement method, a view to be output first when a 2D mode output is set as well as stereo format information of a stereoscopic video signal of a corresponding source of a service. These values are interpreted and used as previously described.

In the StereoformatInformationType XML schema structure, for example, six elements, such as StereoComposition type, LRFristFlag, LROutputFlag, LeftFlippingFlag, RightFlippingFlag, and SamplingFlag, are illustrated as previously described.

The definition and attribute of each element of FIGS. 25 and 26 may be equal to, for example, the field values of FIG. 13. In other words, FIGS. 25 and 26 may define FIG. 12 in the form of an XML schema.

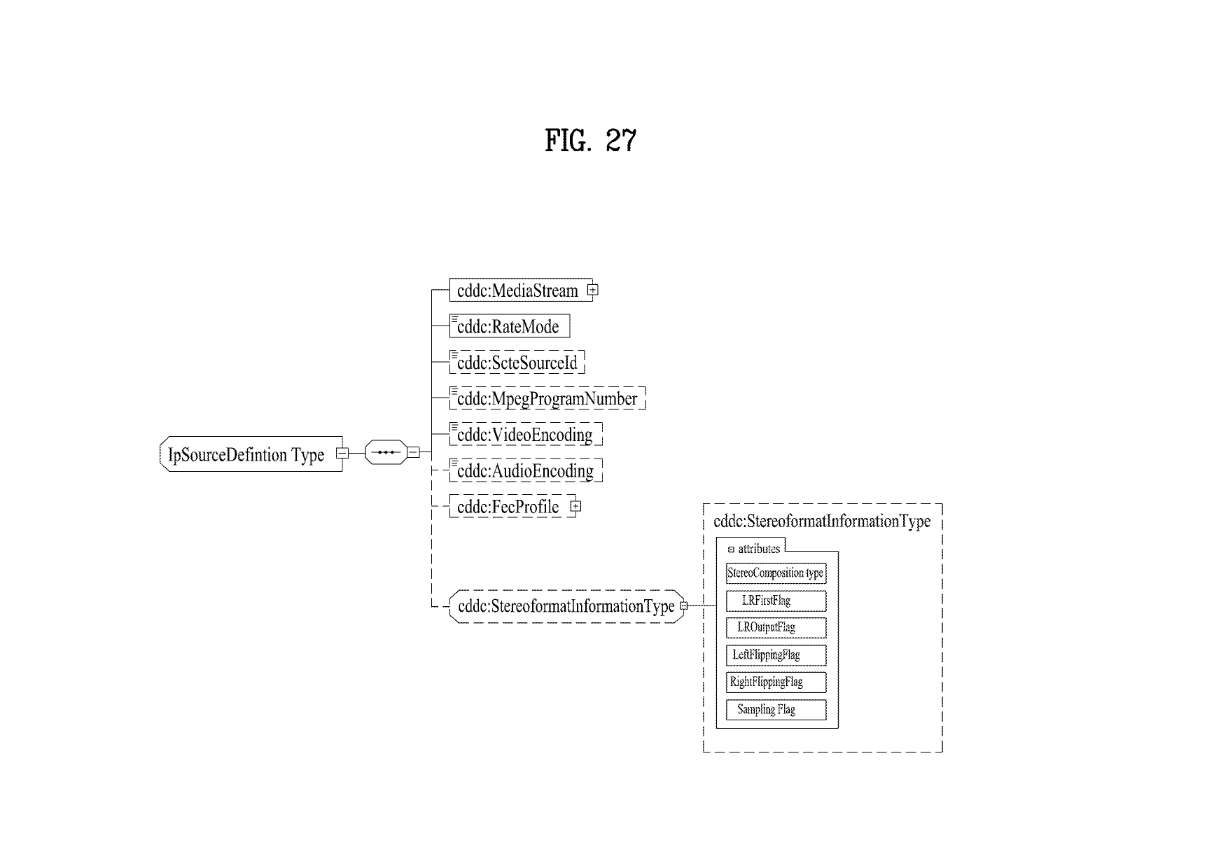

FIG. 27 is a view illustrating an example of an IpSourceDefinitionType XML schema structure according to the present invention.

For example, FIG. 27 configures a StereoformatInformationType value according to the present invention in the form of an XML schema in an IpSourceDefinitionType value.

An IpSourceDefinition Type includes a MediaStream element, a RateMode element, a ScteSourceId element, a MpegProgramNumber element, VideoEncoding and AudioEncoding elements (codec elements), a FecProfile element, and a StereoformatInformation type element.

The MediaStream element includes an IP multicast session description for a media stream of this source. This media stream element includes an asBandwidth attribute. The asBandwidth attribute may be expressed in kilobits per second.

Interpretation of the asBandwidth attribute is the maximum bit rate.

The RateMode element includes a programming source rate type. For example, the RateMode element may include Constant Bit Rate (CBR) or Variable Bit Rate (VBR).

The ScteSourceId element may include a Source ID of an MPEG-2 TS.

The MpegProgramNumber element may include a MPEG Program Number.

The VideoEncoding element indicates a video encoding format of a media source.

The AudioEncoding element may indicate a description regarding audio coding used in a programming source in an audio MIME type form registered in an IANA.

The FecProfile element indicates an IP FEC Profile in a possible case.

The elements shown in FIGS. 25 and 26 are included as sub elements of the StereoformatInformation type element in the IpSourceDefinition Type.

In the above, the codec elements may define codec information regarding a 3D stereoscopic service.

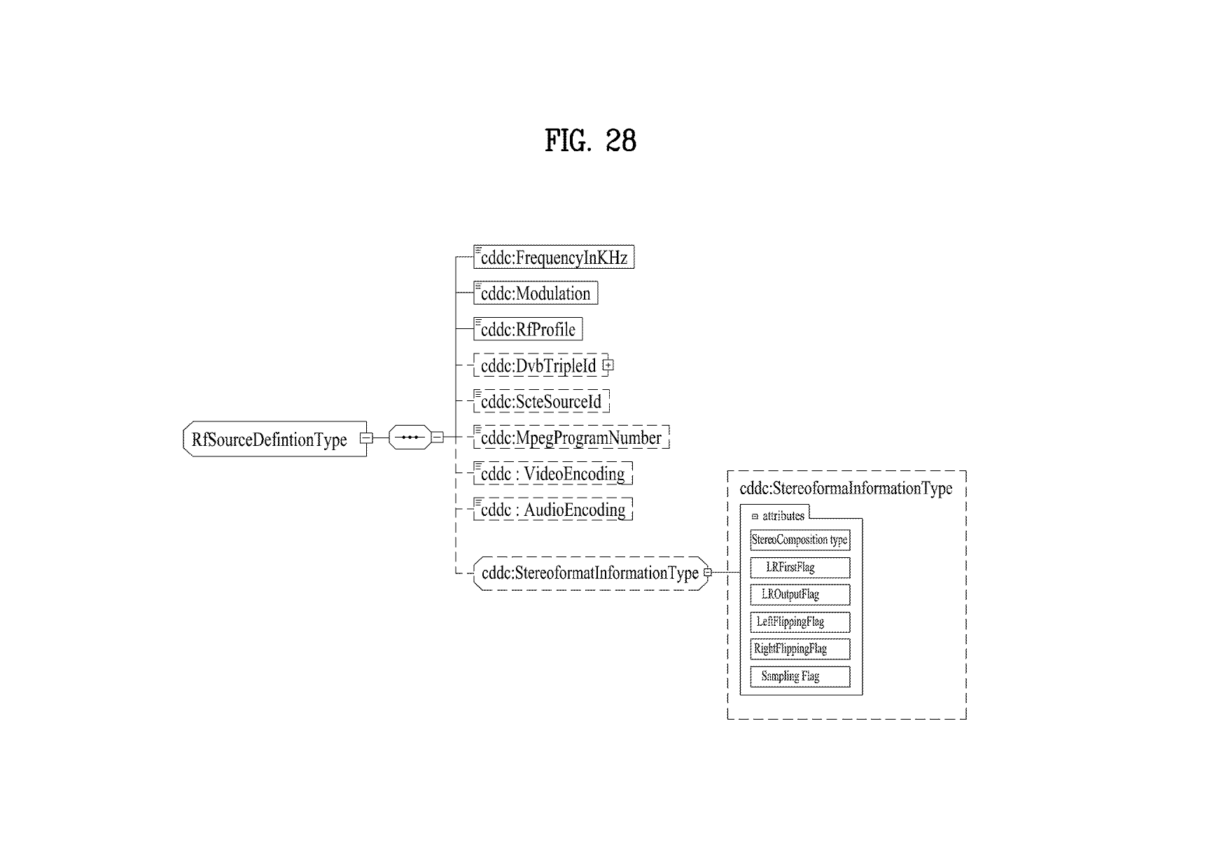

FIG. 28 is a view illustrating an example of an RfSourceDefinitionType XML schema structure according to the present invention

FIG. 28 illustrates an RfSourceDefinitionType XML schema structure. A detailed description of definition and content of each element identical to that of FIG. 27 will be omitted.

In FIG. 28, an RfSourceDefinitionType further includes a FrequencyInKHz element, a Modulation element, an RfProfile element, and a DvbTripleId element according to characteristics thereof.

The FrequencyInKHz element indicates an RF frequency of a source in KHz. This indicates a central frequency irrespective of a modulation type.

The Modulation element indicates a RF modulation type. For example, NTSC, QAM-64, QAM-256, or 8-VSB may be indicated.

The RfProfile element may indicate an elementary stream type. For example, SCTE, ATSC, or DVB may be indicated.

The DvbTripleld element indicates a DVB Triplet identifier for a broadcast stream.

FIGS. 27 and 28 show a method of adding StereoFormatInformation, which is an element of the StereoFormatInformationType, to the IpSourceDefinitionType and the RfSourceDefinitionType to arrange an L/R signal as well as stereo format information for each source and a method of providing information regarding a view to be output first when a 2D mode output is set.

Media of the IPTV include a MPEG-2 TS having a form similar to the existing digital broadcasting and thus are transmitted through an IP network in addition to the method of providing stereo format information through a new signaling end of the IPTV. Consequently, the method of providing stereo format information through various tables of the SI end as previously proposed may be equally applied.

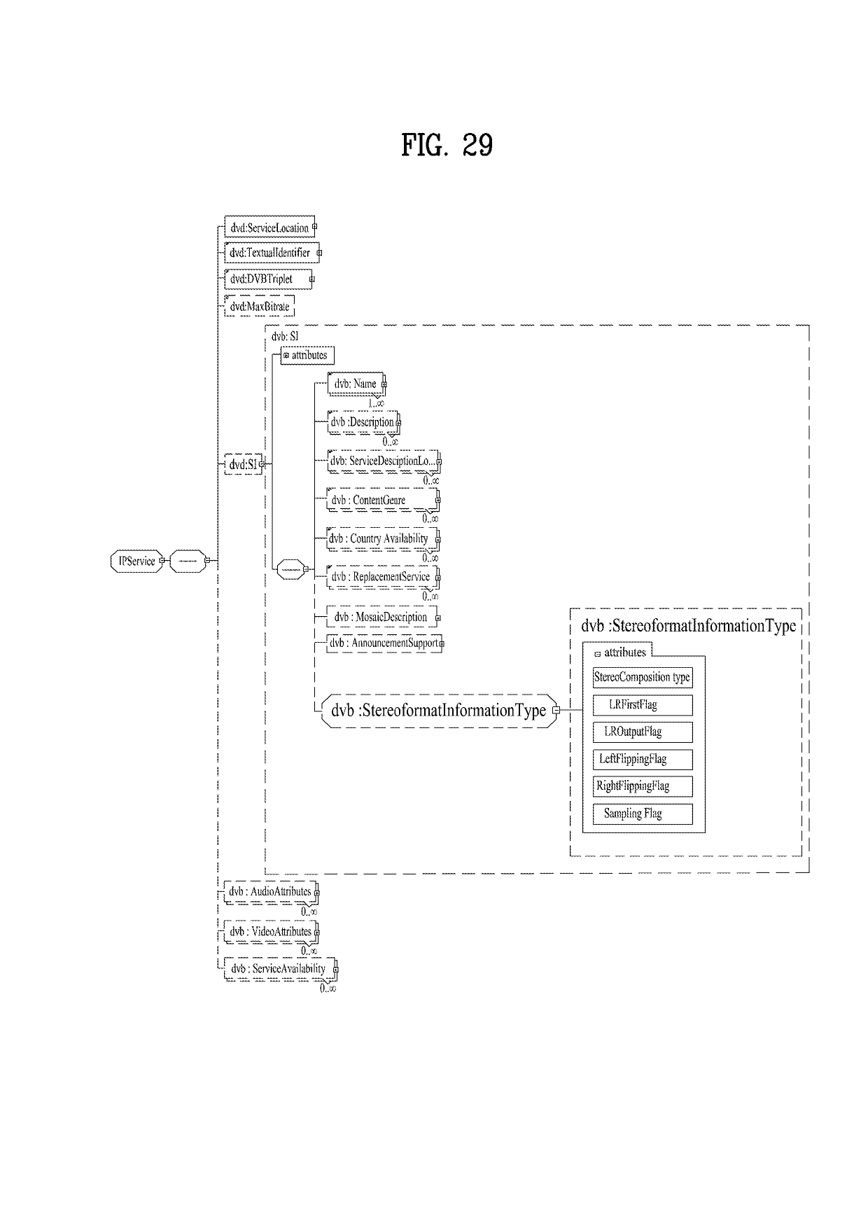

The abovementioned method is related to the ATSC IPTV system. In the DVB IPTV system, on the other hand, an IPService may be extended to provide stereo format information as shown in FIG. 29, which will hereinafter be described.

FIG. 29 is a view illustrating an example of an IPService XML schema structure according to the present invention

FIG. 29 provides information for realization of a 3D stereoscopic service as an IP service and includes StereoformatInformation according to the present invention. However, a detailed description of content and definition of each sub-element will be omitted.

The IPService schema of FIG. 29 may include ServiceLocation, TextualIdentifier, DVBTripleID, MaxBitrate, DVB SI, AudioAttributes, VideoAttributes, and ServiceAvailability elements.

The ServiceLocation element indicates location of the 3D stereoscopic service in the IP service.

The TextualIdentifier element indicates a text type identifier regarding the 3D stereoscopic service in the identified IP service.

The DVBTripleID element indicates a DVB Triplet identifier for a broadcast stream.

The MaxBitrate element indicates the maximum bit rate of the broadcast stream.

The DVB SI element may include attributes and service elements of a service.

The DVB SI element may include a Name element, a Description element, a service description location element, a content genre element, a country availability element, a replacement service element, a mosaic description element, an announcement support element, and a StereoformatInformation element.

The Name element may indicate a service name known to a user in a text from.

The Description element may indicate a text description of a service.

The ServiceDescriptionLocation element may indicate an identifier of a BCG record for a BCG discovery element transmitting the provided information.

The ContentGenre element may indicate the (main) genre of a service.

The CountryAvailability element may indicate a list of countries in which a service is possible or impossible.

The ReplacementService element may indicate details regarding connection to another service in a case in which the provision of a service referred to by an SI record ends in failure.

The MosaicDescription element may indicate a service displayed in a mosaic stream and details regarding a service package.

The AnnouncementSupport element may indicate announcement supported by a service. Also, the AnnouncementSupport element may indicate linkage information regarding announcement location.

The StereoformatInformationType element is the same as the above, and therefore, a detailed description thereof will be omitted.

The AudioAttributes element indicates attributes of audio data transmitted through the broadcast stream.

The VideoAttributes element indicates attributes of video data transmitted through the broadcast stream.

The ServiceAvailability element indicates availability of a service.

In a DVB IPTV system, each IPTV service is expressed in Service Discovery and Selection (DVB SD&S) in unit of IPService. Among these, the SI element provides additional detailed information regarding a service. This information mostly equally provides the content included in an SDT on a DSV SI. In order to extend this, a StereoFormat element is additionally provided as will hereinafter be described. As a result, it is possible to provide stereo format information available for each service.

Even in the DVB IPTV system, it is possible to configure DSV SI information in a TS in the form of an MPEG2 TS in the same manner as previously described and to transmit the DSV SI information through an IP network such that the DSV SI information is used in the same form as in an existing DVB broadcast. Consequently, other methods proposed in the present invention may be equally used.

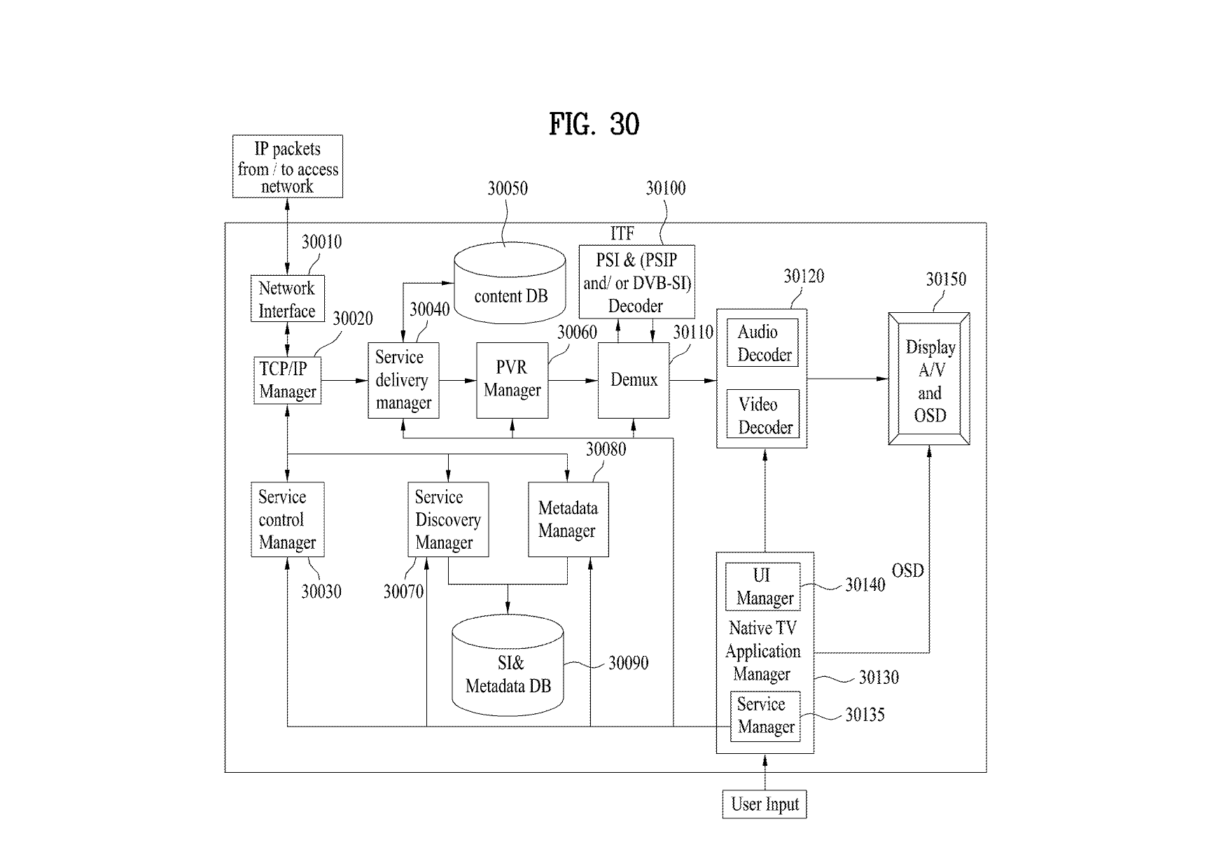

FIG. 30 is a view illustrating another example of a digital receiver to process a 3D service according to the present invention.

FIG. 30 is a view showing an IPTV receiver according to an embodiment of the present invention.

The IPTV receiver according to the embodiment of the present invention includes a Network Interface 30010, a TPC/IP Manager 30020, a Service Control Manager 30030, a Service Delivery Manager 30040, a Content DB 30050, a PVR manager 30060, a Service Discovery Manager 30070, a Metadata Manager 30080, an SI & Metadata DB 30090, an SI decoder 30100, a Demultiplexer (DEMUX) 30110, an Audio and Video Decoder 30120, a Native TV Application manager 30130, and/or an A/V and OSD Displayer 30140.

The Network Interface 30010 serves to transmit/receive an IPTV packet. The Network Interface 30010 is operated in a physical layer and/or a data link layer.

The TPC/IP Manager 30020 participates in transmission of an end to end packet. That is, the TPC/IP Manager 30020 serves to manage transmission of a packet from a source to a destination. The TPC/IP Manager 30020 serves to distribute and transmit IPTV packets to appropriate managers.

The Service Control Manager 30030 serves to select and control a service. The Service Control Manager 30030 may serve to manage a session. For example, the Service Control Manager 30030 may select a real time broadcast service using an Internet Group Management Protocol (IGMP) or an RTSP. For example, the Service Control Manager 30030 may select Video on Demand (VOD) content using the RTSP. For example, in a case in which an IP Multimedia Subsystem (IMS) is used, the Service Control Manager 30030 performs session initialization and/or management through an IMS gateway using a session initiation protocol (SIP). In order to control transmission through TV broadcasting or audio broadcasting as well as transmission on demand, the RTSP protocol is used. The RTSP protocol uses a continuous TCP connection and supports trick mode control for a real time media streaming.

The Service Delivery Manager 30040 participates in real time streaming and/or handling of content downloading. The Service Delivery Manager 30040 retrieves content from the Content DB 30050 for future use. The Service Delivery Manager 30040 may use a Real-Time Transport Protocol (RTP)/RTP Control Protocol (RTCP) together with an MPEG-2 Transport Stream (TS). In this case, an MPEG-2 packet is encapsulated using the RTP. The Service Delivery Manager 30040 parses an RTP packet and transmits the parsed packet to the Demultiplexer 30110. The Service Delivery Manager 30040 may serve to transmit a feedback of network reception using the RTCP. MPEG-2 transport packets may be directly transmitted using a user datagram protocol (UDP) without using the RTP. The Service Delivery Manager 30040 may use a hypertext transfer protocol (HTTP) or a File Delivery over Unidirectional Transport (FLUTE) as a transfer protocol for content downloading. The Service Delivery Manager 30040 may serve to process a stream transmitting 3D video composition information. That is, in a case in which the above 3D video composition information is transmitted by a stream, it may be processed by the Service Delivery Manager 30040. Also, the Service Delivery Manager 30040 may receive, process, or transmit a 3D Scene Depth information stream.

The Content DB 30050 is a database for content transmitted by a content downloading system or content recorded from a live media TV.

The PVR manager 30060 serves to record and reproduce live streaming content. The PVR manager 30060 collects all metadata necessary for recorded content and additional information for better user environment. For example, a thumbnail image or an index may be included.

The Service Discovery Manager 30070 enables search of an IPTV service through a bi-directional IP network. The Service Discovery Manager 30070 provides all information regarding selectable services.

The Metadata Manager 30080 manages processing of metadata.

The SI & Metadata DB 30090 is linked to a metadata DB to manage metadata.

The SI decoder 30100 is a PSI control module. A PSIP or a DVB-SI as well as the PSI may be included. In the following, the PSI is used as a concept including them. The SI decoder 30100 sets PIDs for a PSI table and transmits the set PIDs to the Demultiplexer 30110. The SI decoder 30100 decodes a PSI private section transmitted from the Demultiplexer 30110. The result sets an audio and video PID, which is used to demultiplex input TPs.

The Demultiplexer 30110 demultiplexes audio, video, and PSI tables from input transport packets (TPs). The Demultiplexer 30110 is controlled by the SI decoder 30100 to demultiplex the PSI table. The Demultiplexer 30110 generates PSI table sections and outputs the generated PSI table sections to the SI decoder 30100. Also, the Demultiplexer 30110 is controlled to demultiplex an A/V TP.

The Audio and Video Decoder 30120 may decode video and/or audio elementary stream packets. The Audio and Video Decoder 30120 includes an Audio Decoder and/or a Video Decoder. The Audio Decoder decodes audio elementary stream packets.

The Video Decoder decodes video elementary stream packets.

The Native TV Application manager 30130 includes a UI Manager 30140 and/or a Service Manager 30135. The Native TV Application manager 30130 supports a Graphical User Interface on a TV screen. The Native TV Application manager 30130 may receive a user key from a remote controller or a front panel. The Native TV Application manager 30130 may manage the status of a TV system. The Native TV Application manager 30130 may serve to configure a 3D OSD and control output thereof.

The UI Manager 30140 may control a User Interface to be displayed on the TV screen.

The Service Manager 30135 serves to control managers related to a service. For example, the Service Manager 30135 may control the Service Control Manager 30030, the Service Delivery Manager 30040, an IG-OITF client, the Service Discovery Manager 30070, and/or the Metadata manager 30080. The Service Manager 30135 processes information related to 3D PIP display to control display of a 3D video image.

The A/V and OSD Displayer 30150 receives audio data and video data to control display of the video data and reproduction of the audio data. The A/V and OSD Displayer 30150 may perform video data processing, such as resizing through filtering, video formatting, and frame rate conversion, based on 3D PIP information. The A/V and OSD Displayer 30150 controls output of an OSD. In case of a 3D service as shown in FIG. 17, the A/V and OSD Displayer 30150 may serve as a 3D Output Formatter to receive left and right view images and output the received left and right view images as a Stereoscopic video. During this procedure, a 3D OSD may be output in combination with the video. Also, the A/V and OSD Displayer 30150 may process 3D depth information and transmit the processed information to the UI manager 30140 such that the UI manager 30140 uses the information during outputting of 3D OSD.

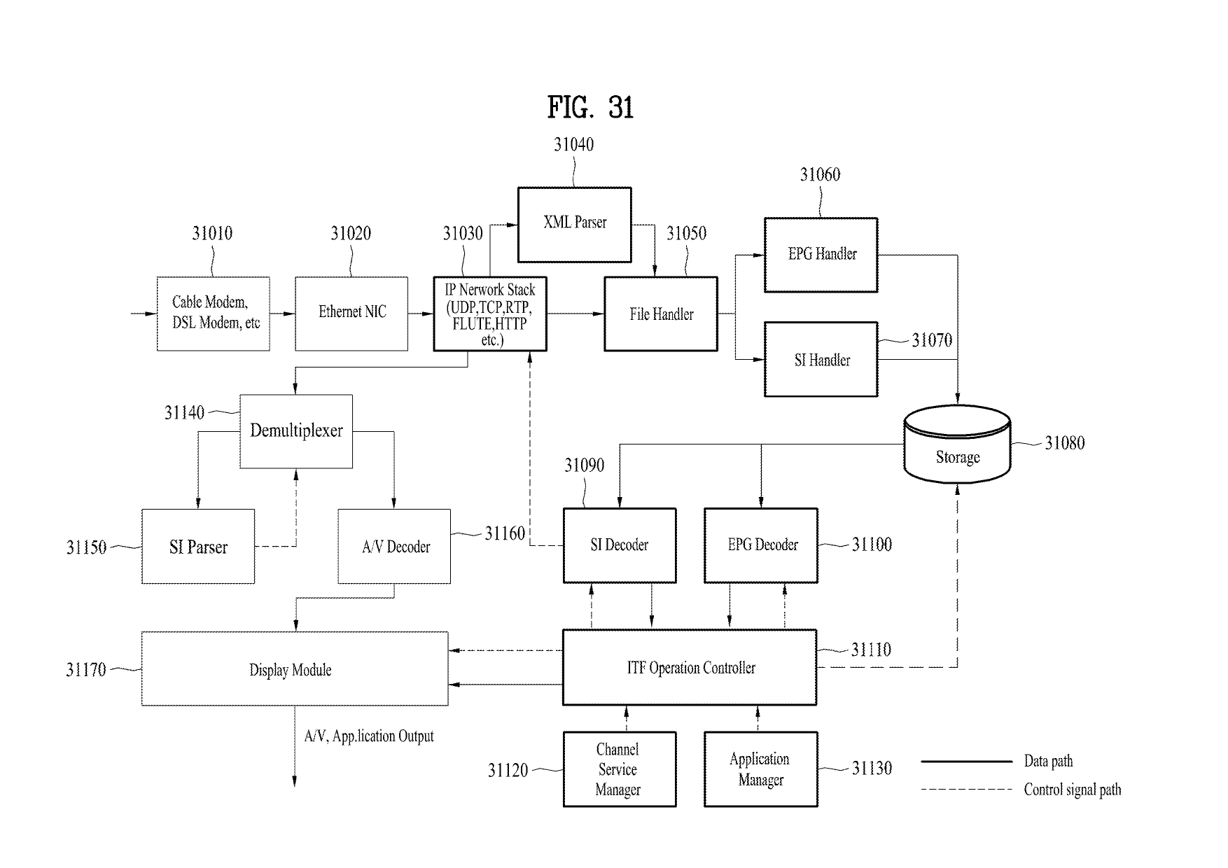

FIG. 31 is a view illustrating a further example of a digital receiver to process a 3D service according to the present invention.

FIG. 31 is a view showing functional blocks of an IPTV receiver according to an embodiment of the present invention.

The functional blocks of the IPTV receiver according to the embodiment of the present invention may include a cable modem/DSL modem 31010, an Ethernet NIC 31020, an IP network stack 31030, an XML parser 31040, a file handler 31050, an EPG handler 31060, an SI handler 31070, a storage unit 31080, an SI decoder 31090, an EPG decoder 31100, an ITF operation controller 31110, a channel service manager 31120, an application manager 31130, a demultiplexer 31140, an SI parser 31150, an audio/video decoder 31160, and/or a display module 31170.

The blocks mainly handled in the present invention are indicated by bold lines. Solid arrows indicate Data paths, and dotted line arrows indicate Control signal paths. The details of the respective functional blocks are as follows.

The cable modem/DSL modem 31010 demodulates a signal transmitted through an interface or a physical medium for connection between an ITF and an IP

Network in a physical layer to restore a digital signal.

The Ethernet NIC 31020 is a module to restore the signal transmitted through the physical interface into IP data.

The IP network stack 31030 is a processing module for each layer based on an IP protocol stack.

The XML parser 31040 is a module to parse an XML document, which is one of the received IP data.

The file handler 31050 is a module to handle data received in the form of a file through FULTE from among the received IP data.

The EPG handler 31060 is a module to handle a portion corresponding to the IPTV EPG data from among the received file type data and store the portion corresponding to the IPTV EPG data in the storage unit.

The SI handler 31070 is a module to handle a portion corresponding to the IPTV SI data from among the received file type data and store the portion corresponding to the IPTV SI data in the storage unit.

The storage unit 31080 is a storage unit to store data, such as SI and an EPG, which are necessary to be stored.

The SI decoder 31090 is a device that reads and analyzes SI data from the storage unit 31080 to restore necessary information if Channel Map information is necessary.

The EPG decoder 31100 is a device that reads and analyzes EPG data from the storage unit 31080 to restore necessary information if EPG information is necessary.

The ITF operation controller 31110 is a main control unit to control the operation of an ITF, such as channel change and EPG display.

The channel service manager 31120 is a module to receive user input and manage an operation, such as channel change.

The application manager 31130 is a module to receive user input and manage an application service, such as EPG display.

The demultiplexer 31140 is a mode to extract MPEG-2 transport stream data from a received IP datagram and transmit the extract MPEG-2 transport stream data to a corresponding module according to each PID.

The SI parser 31150 is a module to extract and parse PSI/PSIP data containing information for access to a program element, such as PID information of the respective data (audio/video) of the MPEG-2 transport stream in the received IP datagram.

The audio/video decoder 31160 is a module to decode the received audio and video data and transmit the decoded audio and video data to the display module.

The display module 31170 combines and processes the received AV signal and OSD signal and output the processed AV signal and OSD signal to a screen and a speaker. The display module 31170 may output a 3D PIP together with a 2D/3D base service according to information related to 3D PIP display. The display module 31170 may perform video data processing, such as resizing through filtering, video formatting, and frame rate conversion, based on 3D PIP information. Also, in case of a 3D video as shown in FIG. 17, the display module 31170 serves to perform separation between L and R view images and to output a 3D image through a formatter. Also, the display module 31170 may serve to process an OSD such that the OSD is displayed together with the 3D image using information related to a 3D depth.

The method invention according to the present invention may be realized in the form of program commands that are executable by various computing means and written in computer readable media. The computer readable media may include program commands, data files, and data structures alone or in a combined state. The program commands recoded in the media may be particularly designed and configured for the present invention or well known to those skilled in the art related to computer software. Examples of the computer readable media may include magnetic media, such as a hard disk, a floppy disk, and a magnetic tape, optical media, such as a compact disc read only memory (CD-ROM) and a digital versatile disc (DVD), magneto-optical media, such as a floptical disk, and hardware devices, such as a read only memory (ROM), a random access memory (RAM), and a flash memory, which are particularly configured to store and execute program commands. Examples of the program commands may include high-level language codes executable by a computer using an interpreter as well as machine language codes generated by a complier. The hardware devices may be configured to function as one or more software modules to perform the operation of the present invention, or vice versa.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### MODE FOR INVENTION

Various embodiments have been described in the best mode for carrying out the invention.

### INDUSTRIAL APPLICABILITY

As is apparent from the above description, the present invention may be fully or partially applied to a digital broadcasting system.

1. A three-dimensional (3D) video data processing method comprising:
receiving a broadcast signal comprising 3D video data and service information;
identifying whether a 3D service is provided in a corresponding virtual channel from a first signaling table in the service information;
extracting a stereo format descriptor comprising a service identifier and first component information regarding the 3D service from the first signaling table;
reading second component information corresponding to the first component information from a second signaling table having a program number mapped with the service identifier for the virtual channel and extracting elementary Packet Identifier (PID) information based on the read second component information;
extracting stereo format information regarding a stereo video element from the stereo format descriptor; and
decoding and outputting the stereo video element based on the extracted stereo format information.

2. The 3D video data processing method according to claim 1, wherein the stereo format information comprises at least one selected from among stereo configuration information, left/right disposition information, left/right priority output information, and left/right reverse scanning identification information.

3. The 3D video data processing method according to claim 2, wherein the stereo format information further comprises format information of a video stream.

4. The 3D video data processing method according to claim 3, wherein the service information comprises DVB-SI information.

5. The 3D video data processing method according to claim 4, wherein the first signaling table is an SDT, and the second signaling table is a Program Map Table (PMT).

6. The 3D video data processing method according to claim 5, wherein the step of identifying whether the 3D service is provided is carried out through a service_type field of the Service Description Table (SDT) and/or the stereo format descriptor.

7. The 3D video data processing method according to claim 6, wherein the step of outputting the stereo video element comprises decimating and outputting only data corresponding to a view of the decoded stereo video element selected based on at least one selected from among the left/right disposition information, the left/right priority output information, and left/right reverse scanning identification information in the stereo format descriptor in a case in which a view mode is a 2D mode.

8. The 3D video data processing method according to claim 6, wherein the step of outputting the stereo video element comprises resizing and/or format converting and outputting the decoded stereo video element according to a display type based on at least one selected from among the stereo configuration information, the left/right disposition information, the left/right priority output information, and left/right reverse scanning identification information in the stereo format descriptor in a case in which a view mode is a 3D mode.

9. The 3D video data processing method according to claim 4, wherein the first signaling table is an Event Information Table (EIT).

10. The 3D video data processing method according to claim 6, further comprising identifying whether a stream type of the video stream for the identified 3D service is a side-by-side mode or a top-bottom mode.

11. A three-dimensional (3D) broadcast receiver comprising:
a receiving unit to receive a broadcast signal comprising 3D video data and service information;
a system information processor to acquire a first signaling table and a second signaling table in the service information and to acquire stereo format information from the first signaling table and the second signaling table;
a controller to identify whether a 3D service is provided in a corresponding virtual channel from the first signaling table, to control a service identifier to be read from the first signaling table, first component information regarding the 3D service and stereo format information regarding a stereo video element to be read from the stereo format information, and second component information corresponding to the first component information to be read from the second signaling table having a program number mapped with the service identifier for the virtual channel, and to control elementary Packet Identifier (PID) information to be extracted based on the read second component information;
a decoder to decode the stereo video element based on the extracted stereo format information; and
a display unit to output the decoded 3D video data according to a display type.

12. The 3D broadcast receiver according to claim 11, wherein the stereo format information comprises at least one selected from among stereo configuration information, left/right disposition information, left/right priority output information, and left/right reverse scanning identification information.

13. The 3D broadcast receiver according to claim 12, wherein the stereo format information further comprises format information of a video stream.

14. The 3D broadcast receiver according to claim 13, wherein the service information comprises DVB-SI information.

15. The 3D broadcast receiver according to claim 14, wherein the first signaling table is an SDT, and the second signaling table is a Program Map Table (PMT).

16. The 3D broadcast receiver according to claim 15, wherein the controller identifies whether the 3D service is provided through a service_type field of the Service Description Table (SDT) and/or the stereo format descriptor.

17. The 3D broadcast receiver according to claim 16, wherein the controller controls the display unit to decimate and output only data corresponding to a view of the decoded stereo video element selected based on at least one selected from among the left/right disposition information, the left/right priority output information, and left/right reverse scanning identification information in the stereo format descriptor in a case in which a view mode is a 2D mode.

18. The 3D broadcast receiver according to claim 16, wherein the controller controls the display unit to resize and/or format convert and output the decoded stereo video element according to the display type based on at least one selected from among the stereo configuration information, the left/right disposition information, the left/right priority output information, and left/right reverse scanning identification information in the stereo format descriptor in a case in which a view mode is a 3D mode.

19. The 3D broadcast receiver according to claim 14, wherein the first signaling table is an Event Information Table (EIT).

20. The 3D broadcast receiver according to claim 16, wherein the controller identifies whether a stream type of the video stream for the identified 3D service is a side-by-side mode or a top-bottom mode from at least one selected from among the first signaling table, the second signaling table, and the stereo format information.
